(19) United States
(12) Patent Application Publication
(10) Pub. No.: US 2016/0188125 A1
(43) Pub. Date: Jun. 30, 2016

(54) METHOD TO INCLUDE INTERACTIVE OBJECTS IN PRESENTATION

(71) Applicant: LINTELUS, INC., Mission Viejo, CA (US)

(72) Inventors: Diego Andres Kaplan, San Diego, CA (US); Stephen G. Petilli, San Juan Capistrano, CA (US); Mohammed Fathi Hakam, Ladera Ranch, CA (US); Colin Ayer, Laguna Niguel, CA (US); Geraldine Cerkovnik, Aliso Viejo, CA (US); Gavin S. Petilli, San Juan Capistrano, CA (US); Konstantin G. Mikhailov, Nizhny Novgorod (RU); Anton S. Pavlov, Nizhny Novgorod (RU); Vladimir V. Krylov, Nizhny Novgorod (RU); Alexey Zaytsev, Nizhny Novgorod (RU); Olga Audzit, Nizhny Novgorod (RU); Oleg Brichev, Nizhny Novgorod (RU); Dmitriy Yaroslavlev, Cheboksary (RU)

(21) Appl. No.: 14/834,322

(22) Filed: Aug. 24, 2015

Related U.S. Application Data
(60) Provisional application No. 62/145,977, filed on Apr. 10, 2015.
(60) Provisional application No. 62/137,117, filed on Mar. 23, 2015.
(60) Provisional application No. 62/098,606, filed on Dec. 31, 2014.
(60) Provisional application No. 62/098,288, filed on Dec. 30, 2014.
(60) Provisional application No. 62/074,566, filed on Nov. 3, 2014.
(60) Provisional application No. 62/072,642, filed on Oct. 30, 2014.
(60) Provisional application No. 62/041,098, filed on Aug. 24, 2014.

(51) Int. Cl. G06F 3/0481; G06F 17/22

(52) U.S. Cl. CPC G06F 3/0481; G06F 17/2247

(57) ABSTRACT

A system for real-time interactive presentation, the system communicatively coupled to a network for access by a plurality of user devices comprising a database to store information relating to a plurality of presentations, at least one processor executing instructions stored in non-transitory memory that cause the processor to: receive a presentation in a first format from a presenter user device, convert the presentation to an HTML5 format, embed at least one HMTL5 interactive object into the converted presentation, store the converted presentation including the at least one HTML5 interactive embedded object in the database, upon a request received from a first user device for the converted presentation, transmit the converted presentation including the at least one HTML5 interactive embedded object to the first user device, wherein the presentation including the at least one HTML5 interactive embedded object is rendered for viewing on a display of the first user device, and receive and store first user input data from the first user device in the database when a first user has interacted with the at least one HTML5 interactive embedded object.

### CROSS REFERENCE TO RELATED APPLICATIONS

The present application claims priority to U.S. Provisional Application Ser. No. 62/041,098, filed Aug. 24, 2014 for “Method to Include Interactive Objects in Presentation,” U.S. Provisional Application Ser. No. 62/074,566, filed Nov. 3, 2014 for “Systems and Methods for Including Interactive Objects in a Presentation,” U.S. Provisional Application Ser. No. 62/072,642, filed Oct. 30, 2014 for “Presentation Coach for Smart Eyewear,” U.S. Provisional Application Ser. No. 62/098,288, filed Dec. 30, 2014 for “Lintelus/Roadrunner Features,” U.S. Provisional Application Ser. No. 62/098,606, filed. Dec. 31, 2014 for “Systems and Methods for Downloading Presentation Audio Associated With at Least One Slide,” U.S. Provisional Application Ser. No. 62/145,977, filed Apr. 10, 2015 for “Presentation Classroom Features,” and U.S. Provisional Application Ser. No. 62/137,117, filed Mar. 23, 2015 for “Lintelus Share Classroom Features,” which are hereby incorporated by reference in their entirety and for all purposes.

### BACKGROUND OF THE INVENTION

Presenting is the art of conveying a message to an audience. Presentations are a vital teaching and information sharing tool. Effectively conveying information to an audience is important in business, politics, science, medicine, academia, and many other industries.

Effective presentations should provide a way to extend the functionality of a presentation to include interactive features. Applications in the market today provide remote viewing of presentations, screen sharing, white boards, polls and surveys, etc. However, there is a lack of an extensible architecture that would allow for easy inclusion of interactivity into a presentation, for example, in PowerPoint or PDF. Also, analytics for interactive features are currently lacking. Therefore, systems and methods for creation tools and analytics can be beneficial for presenters.

Additionally, a presenter can have many shortcomings, such as speaking too softly, too quickly or too slowly. Presenters occasionally stare at a single location in the audience or gesticulate with their hands or facial features in a distracting manner which can detract from the content that the presenter wishes to convey. Some solutions include practicing before a presentation and receiving coaching before or after a presentation. Improved presentation coaching including a real-time notification system and methods can be beneficial for presenters.

When attending a presentation, attendees often take notes which apply to a slide. Pairing the note to the slide allows the attendee to later recall what was being discussed and help understand the presentation better. Sometimes however, the words from the presenter provide a lot more information than the slides and the notes do. It would be advantageous to be able to review a slide by not only seeing it with its associated notes, but also hearing its accompanying audio.

The above inventions are aimed at utilizing features of user devices such as mobile devices to promote audience engagement.

The field of cloud-based presentations where the presenter's screen is duplicated on the attendee's device is relatively new, so what is available is limited. The above features combine existing technologies with new presentation functionality.

### SUMMARY OF THE INVENTION

Provided herein are embodiments of a device, system, and method for providing interactive features in a presentation.

The devices, systems and methods disclose herein a multiuser presentation application that compile a PowerPoint, PDF or other format presentation file into HTML5. The presentation data is then hosted on a server and provided to users on user devices via a network, for example, the Internet. The users can display the presentation one slide or page at a time in a browser.

Generally, a presentation application accepts a presentation file, including, but not limited to, PowerPoint or PDF file, as input and has a compiler that translates the presentation into HTML5 for display in browsers. The HTML5 format allows the presentation to display with maximum resolution in all web browsers while keeping a small size. As an added benefit, it allows for easy inclusion of applets to provide interactivity.

In some embodiment, the presentation application creates container objects that can be provided to users to embed in their presentation. When these objects are detected by the presentation compiler, they can be replaced with small applets that allow for user interaction. Each object can be designed to accept data and parameters. When the presentation is run, the clients execute the code, which allows each attendee viewing the presentation to do something different, the data is then posted to the server, and it can choose to aggregate it and display it in multiple ways to the audience. In other embodiments, users can directly edit HTML5 presentations to insert poll slides (input and results) into a slide list.

The presentation application allows inclusion of interactive features when creating the presentation. In an embodiment, the presentation application creates special pre-defined container objects, which can be included in the presentation when it is created. When the HTML5 presentation compiler comes across these objects, it can extract their parameters and build HTML5 objects in their place. Using HTML5 allows for JavaScript code to be embedded in the layout.

In some embodiments, a presenter can insert interactive slide features directly into a compiled presentation, such as directly into HTML5 by the application's client. For example, this feature can be used to include polls and annotation tools.

In another embodiment, the presentation application may use video compression formats as a container for presentation slides.

In yet another embodiment, the presentation application may implement web application data as a synchronized database. An application's logic can be static and served separately from an application server.

Also provided herein are embodiments of a device, system, and method for tracking a presenter's behavior and providing real-time coaching and recommendations. These devices, systems and methods can use sensors, including those integrated in or communicatively coupled with smart eyewear, in order to analyze a presenter's behavior, mannerisms, and effectiveness. Based on the analysis, the smart eyewear can provide real-time recommendations to the presenter in order to coach the presenter to be more effective and engaging in conveying points to the audience.

Also provided herein are features to enhancement a cloud-based presentation application which lets attendees see the presentation on a connected device, including:

Vibrate transition: This feature can allow a presenter to use a vibrate feature of a cell phone, tablet or other mobile device as a transition for their presentation that will vibrate the audience's devices at desired points during the presentation. When creating presentations using applications such as PowerPoint, it can be common to define effects for slide transitions. When showing these types of presentations using a cloud-based system that replicates the presenter's screen across attendee's devices, additional features provided by those devices can become available to the presenter's toolbox. In various embodiments, vibrate functionality that is present in most mobile devices can be utilized to attract the user's attention when the slide changes. Alternatively or additionally, the vibration function can be used to grab the audience's attention during particular points in a presentation. In some embodiments the vibration function can be used as an indicator to individual audience members. A particular sequence or set of vibrations can be used to indicate a correct or incorrect answer to a question, a selection for participation, or various others.

Picture poll: This feature can be a poll type where members of the audience participate by allowing their mobile device to take a picture of their face. The presenter can then show the results of the poll and use the audience members' faces behind the results on a presentation screen. The pictures can also be used to promote interaction between the presenter and audience members.

Picture poll with facial recognition: Similar to the picture poll, the application can analyze a picture and infer a user's mood. This can be used with a mood meter that can be overlaid on top of a poll screen. The picture taken by the user can be analyzed with face recognition software to obtain a mood. The mood can then be added to data uploaded to a server and used to calculate an overall audience mood that is displayed on a screen as a mood meter.

A cloud-based presentation application provides the capability to run polls during a presentation. An additional feature that augments the functionality of the standard polling feature can allow audience members to take their pictures using their devices' cameras and upload them to a server as part of the poll data. When displaying the poll results, the server can then use the images to create a background that is engaging to the audience. In some embodiments pictures can be displayed on a presenter's device and be associated with the individual audience member's name. The presenter can then interact with the individual audience member and discuss why they selected a particular answer.

Pulse poll: A pulse of individual audience members can be taken from sensors and an average pulse can be calculated and displayed in a pulse meter on the screen. Included are embodiments that are additions to the functionality of presentation applications to further enhance interactive functionality by promoting attention and audience participation. In this case, the attendees' devices can determine if they are connected to fitness sensors and if so, they can request and upload the individual attendees pulse to the server, which can use the data to create an average audience pulse. This audience pulse can be shown on a pulse meter on the screen to estimate audience excitement. Connection can be wireless or wired in various embodiments. In some embodiments individual attendees need not have their own devices but fitness devices can connect directly to the server. Other manipulations of the data can determine excitement of different subsets of the audience such as men, women, children, ethnic groups, religious groups, age groups, affiliations such as employees of particular companies, and many others as appropriate.

Also disclosed herein is a multiuser presentation system allows a presenter to show a presentation on the screen and attendees to see a copy of the presentation on their devices. The system can also allow attendees to take notes, which are associated with the current slide and can be later downloaded with the slides attached. The system can allow recording of the presenter's speech and partitions the audio based on which slide is being shown. When attendees download notes, they can also download the audio fragments that correspond the slides for which they wrote the notes. Being able to hear the presenter and see the slide, can provide a better understanding of the slide and the notes for attendees and can enhance a review of the presentation. To summarize, the system provides the following functionality: it can record audio from the presenter; segments the audio according to which slide is being shown and a timestamp allowing the entire presentation to be reconstructed by joining the segments in increasing order of time and allowing the system to provide more than one audio segment per slide if the presenter goes back to a previous slide; allowing a user to playback the presentation after it has been completed by maintaining a synchronization between the slide and the audio, where the playback allows skipping slides and maintains the audio in sync; allowing a user to download slide notes with the corresponding matching audio; and allowing a presenter to do a dry run of the presentation and obtain slide times that can be used later to help pace the presentation.

Some prior art functionality includes: PowerPoint allows the presenter to write slide notes; Slideshare allows presentations to be publicly shared and provides a player that allows advancing of slides; Webcasting systems allow a presentation with audio and video to be shared with users and be shown later and users can skip to sometime later in the presentation.

Advancement disclosed herein include a system can provide a presentation as a set of slides that can be viewed similar to a PowerPoint presentation but by marking audio with slide start/end information, the disclosed audio player can maintain each slide and its corresponding audio in sync. At least one novel feature is being able to skip slides and keep the audio in sync. Also, allowing an attendee to download his/her notes and having them include audio provides obvious benefits.

Additionally disclosed herein are features for teachers and other presenters using the system to deliver in-class lectures including attendance tracking, note-taking, automatic quizzes, grading and real-time reports that include test results and statistical analysis. The system is a client-server solution, and in some embodiments a database with lecture history and multiple-lecture features are recorded. In some embodiments the system can track individual student trends to see whether they are getting improving or declining in various metrics, overall class trends can be recorded and other metrics can be analyzed. Some of these features include:

Attendance and engagement: the system can track students that login to maintain an attendance log, including the following: Punctuality—Was the student on time? Engagement level including did the student take notes? Did he/she switch applications during the class? How long were applications switched? Did the student follow in a timely manner, such as following slide changes within a reasonable prescribed time such as thirty seconds? Did the student stay until the end of the class? Did the student use the system to ask questions?

Personalized lecture quizzes: the system can allow a teacher or presenter to provide zero or more questions per slide, including at least one correct answer and multiple erroneous answers. Questions can be true/false, multiple choice, essay/short answer and others. The teacher can then define a number of questions for a test and how many possible answer choices to show. The system then builds tests at random choosing the required number of questions, and for each question the required number of answers. The questions and answers can be shuffled in random order to make copying from a neighbor difficult.

Personalized and multi-user topic-related games: The system provides a markup mechanism for a teacher or presenter to highlight important words in the slides. The teacher or presenter can then provide definitions for these words (as well as whether the words are verbs, nouns, etc.) and the system can use the words and definitions to provide topic-related games such as crosswords or trivia questions that students can try to solve individually or cooperatively on a shared screen. While one example is a crossword generator, there are other possibilities that can be provided using the available information (for example, complete a sentence by adding the missing word or guess the word from the definition). As with quizzes, the system can randomize the puzzles created such that each student gets a different puzzle to solve to avoid copying.

Real-time reporting: the system can provide real-time reports of class engagement to one or more of the teacher, students, and administrators.

A public report for display on a large screen to the class, showing attendance and engagement, the current time, progress through a lecture, slides or other presentation materials, and, during a quiz, expected progress and time remaining

A private report for the teacher that shows additional information such as real-time average/best/worst progress for the whole class, time per question and score, attendance, engagement based on metrics related to the information above, per student comparisons, subsection/group metrics, per student engagement over multiple class sessions, progress over multiple class sessions, etc.

One or more instantly scored quizzes with feedback delivered to each student upon completion showing for each question: a corresponding slide (if any), a question asked with answer choices, a correct answer, and/or a student answer (if different from the correct answer).

Other features and advantages of the present invention will become apparent from the following more detailed description, taken in conjunction with the accompanying drawings, which illustrate, by way of example, the principles of the present invention.

### BRIEF DESCRIPTION OF THE SEVERAL VIEWS OF THE DRAWING(S)

Illustrated in the accompanying drawing(s) is at least one of the best mode embodiments of the present invention. In such drawing(s):

FIG. 1a illustrates a network architecture according to an example embodiment.

FIG. 1b illustrates a network architecture according to an example embodiment.

FIG. 2 illustrates a server architecture according to an example embodiment.

FIG. 3 illustrates a device with an applet according to an example embodiment.

FIG. 4 illustrates an example embodiment of a user interface showing a main screen with a polls tab.

FIG. 5 illustrates an example embodiment of a user interface showing a polls history page.

FIG. 6a illustrates an example embodiment of a user interface showing a polls history window.

FIG. 6b illustrates an example embodiment of a user interface showing a polls history window with menu.

FIG. 7 illustrates an example embodiment of a user interface showing a polls history detail view.

FIG. 8 illustrates an example embodiment of a user interface showing a multiple choice poll creation page.

FIG. 9 illustrates an example embodiment of a user interface showing a poll rating page.

FIG. 10 illustrates an example embodiment of a user interface showing a poll editing page.

FIG. 11 illustrates an example embodiment of a user interface showing a poll object added to a presentation.

FIG. 12a illustrates an example embodiment of a user interface showing a picture preview with a first size.

FIG. 12b illustrates an example embodiment of a user interface showing a picture preview with a second size.

FIG. 13 illustrates an example embodiment of a user interface showing a poll creation button.

FIG. 14 illustrates an example embodiment of a user interface showing image additions to a poll.

FIG. 15 illustrates an example embodiment of a user interface showing picture selection from a variety of sources.

FIG. 16 illustrates an example embodiment of a user interface showing picture preview selection.

FIG. 17 illustrates an example embodiment of a user interface showing a poll saving screen.

FIG. 18 illustrates an example embodiment of a user interface showing a poll preview page.

FIG. 19 illustrates an example embodiment of a user interface showing a poll results preview page.

FIG. 20 illustrates an example embodiment of a user interface showing a poll participant display.

FIG. 21 illustrates an example embodiment of a user interface showing a poll results page.

FIG. 22 illustrates an example embodiment of a user interface showing a poll question page.

FIG. 26 illustrates an example embodiment of a user interface showing a poll answer results page.

FIG. 24 illustrates an example embodiment of a user interface showing a combined poll with image and answers.

FIG. 25 illustrates an example embodiment of a user interface showing a poll results page.

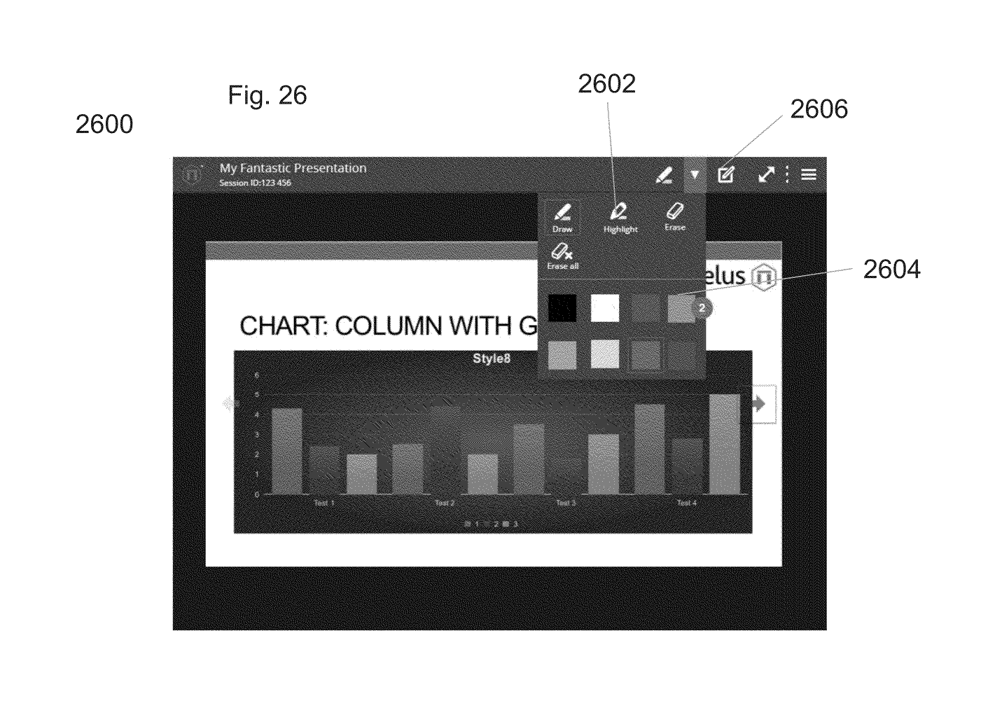

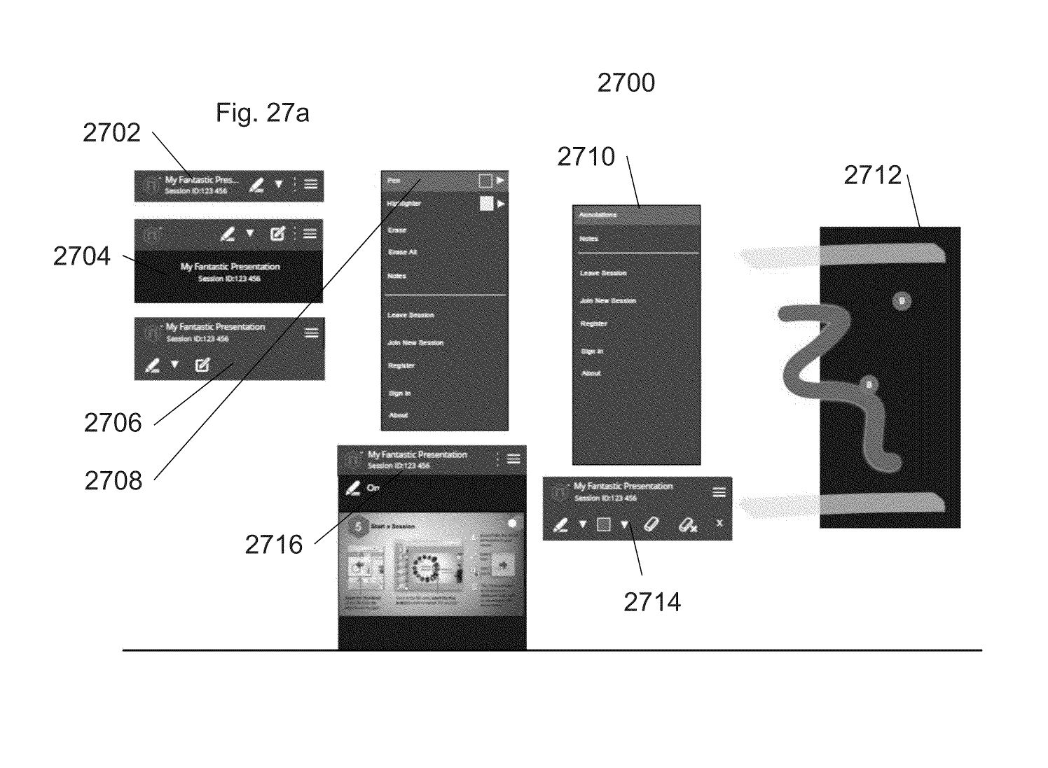

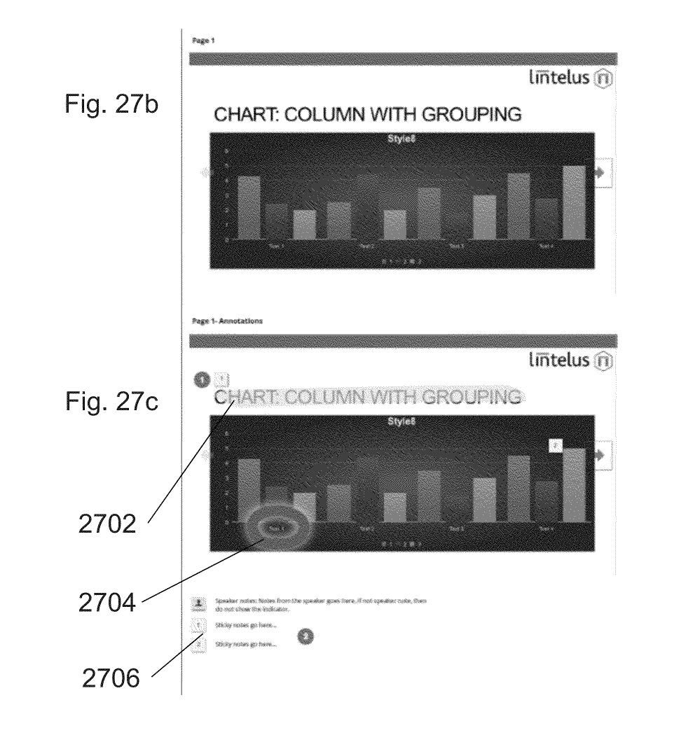

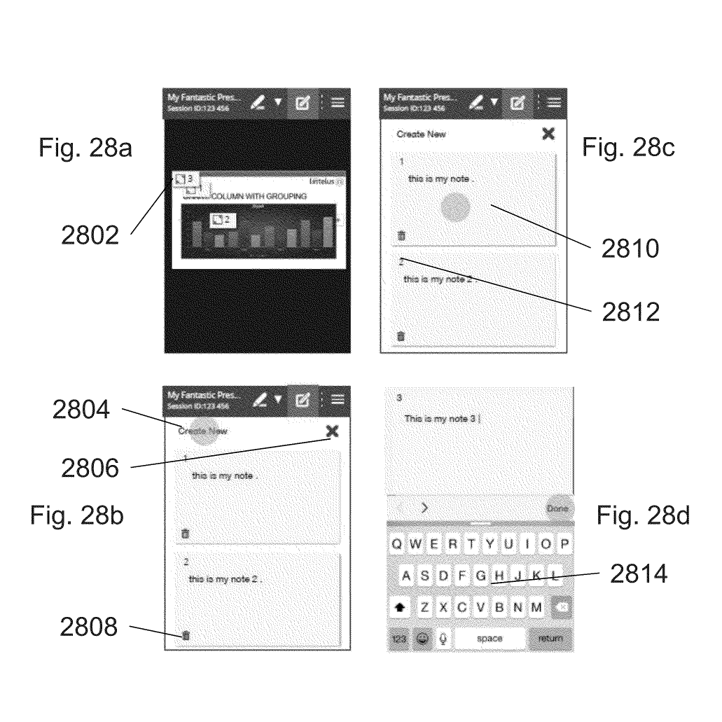

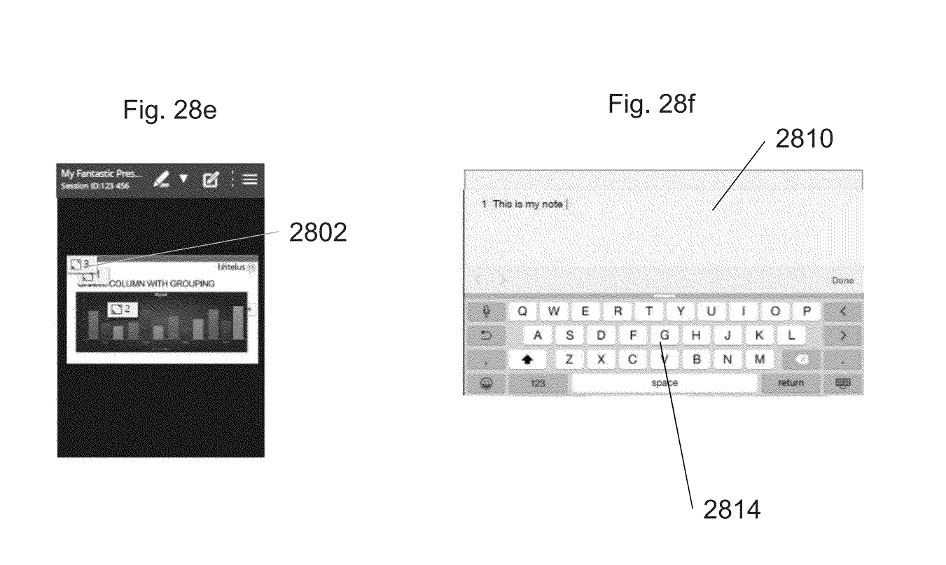

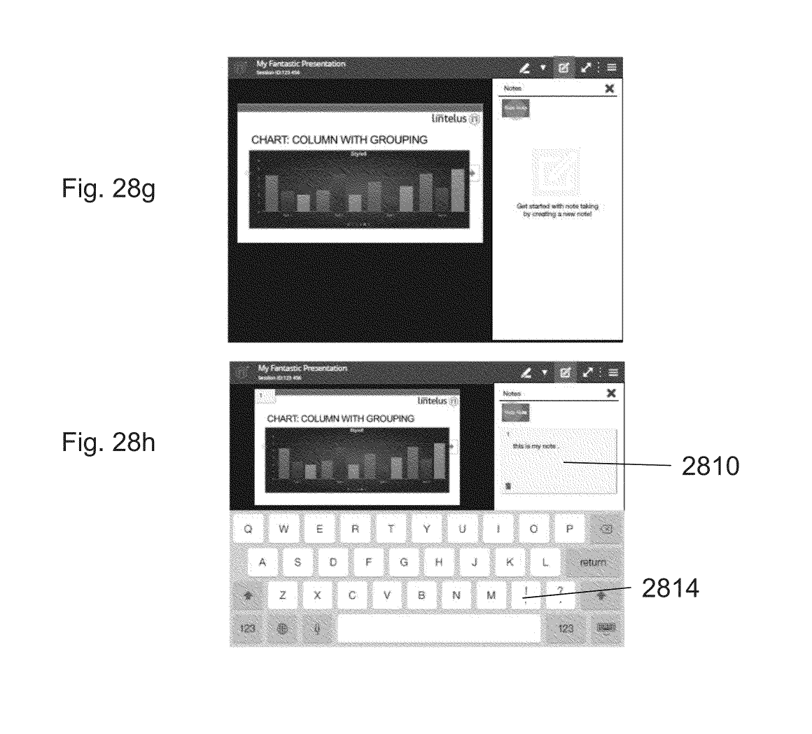

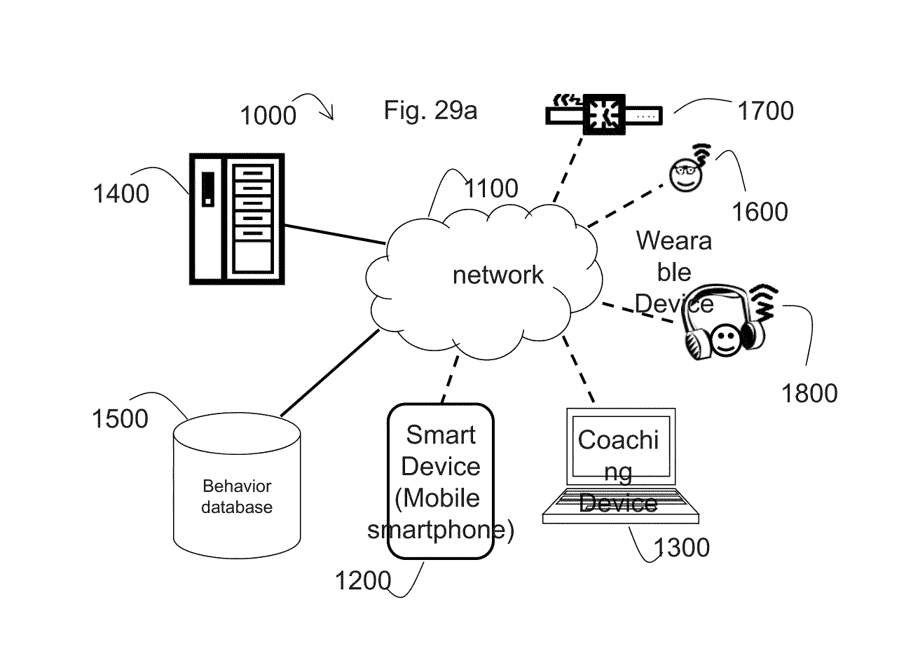

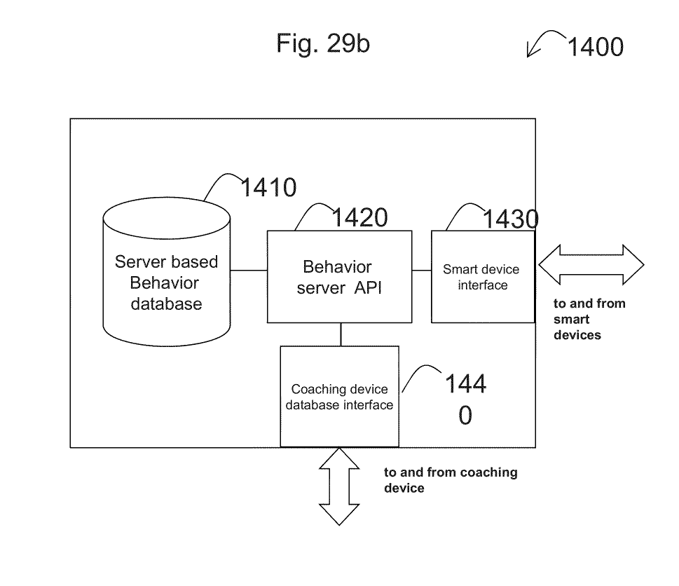

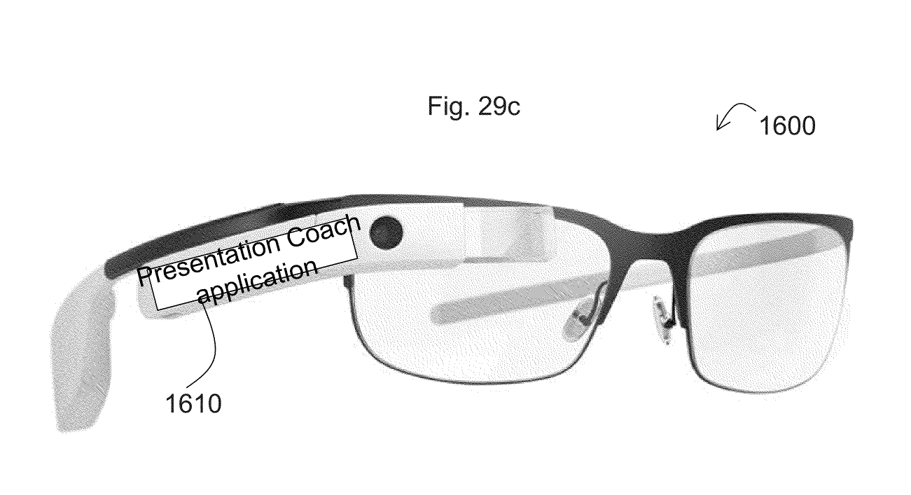

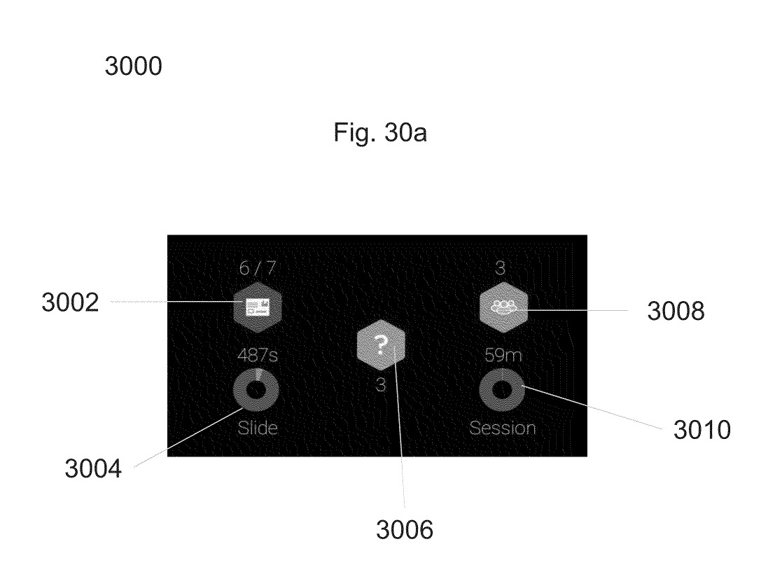

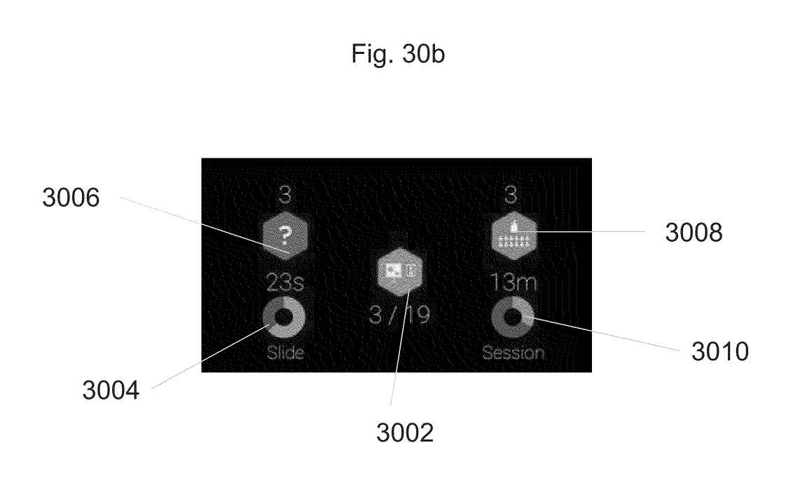

FIG. 26 illustrates an example embodiment of a user interface showing an interaction screen.

FIG. 27a illustrates an example embodiment of a user interface showing a variety of menus and tools.

FIG. 27b illustrates an example embodiment of a user interface showing an unmarked slide.

FIG. 27c illustrates an example embodiment of a user interface showing a marked slide.

FIGS. 28a-28h illustrate example embodiments of various sticky note functions.

FIG. 29a illustrates a network architecture according to an example embodiment.

FIG. 29b illustrates a server architecture according to an example embodiment.

FIG. 29c illustrates a device with an installed presentation coach application according to an example embodiment.

FIGS. 30a-30b illustrates a user interface according to an example embodiment.

### DETAILED DESCRIPTION OF THE PREFERRED EMBODIMENTS

The above described figures illustrate the described invention and method of use in at least one of its preferred, best mode embodiment, which is further defined in detail in the following description. Those having ordinary skill in the art may be able to make alterations and modifications to what is described herein without departing from its spirit and scope. While this invention is susceptible of embodiment in many different forms, there is shown in the drawings and will herein be described in detail a preferred embodiment of the invention with the understanding that the present disclosure is to be considered as an exemplification of the principles of the invention and is not intended to limit the broad aspect of the invention to the embodiment illustrated. All features, elements, components, functions, and steps described with respect to any embodiment provided herein are intended to be freely combinable and substitutable with those from any other embodiment unless otherwise stated. Therefore, it should be understood that what is illustrated is set forth only for the purposes of example and should not be taken as a limitation on the scope of the present invention.

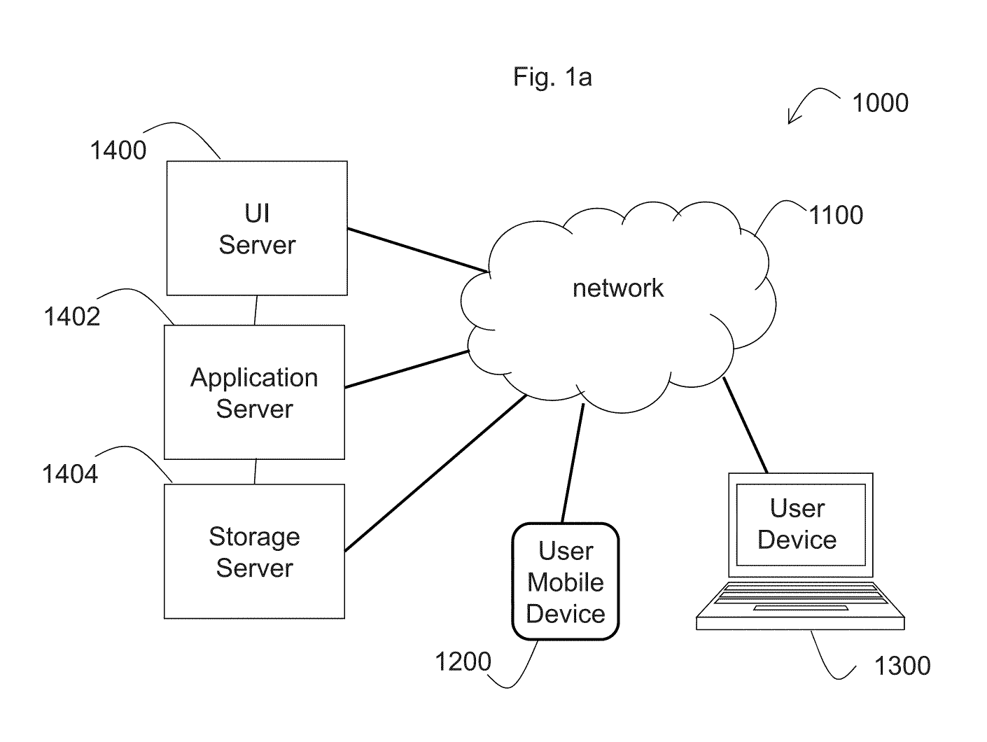

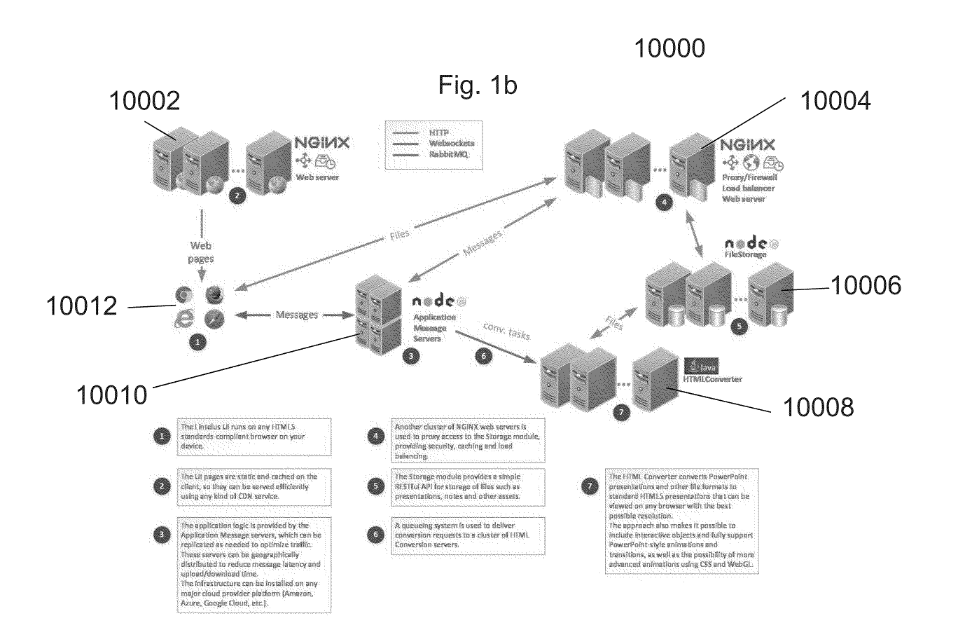

Turning to FIG. 1a, an example embodiment of a presentation platform 1000 is shown. In the example embodiment, the three servers which clients can connect to include: UI server 1400 which can serve UI code for clients, Application server 1402 which can handle application databases and logic, and Storage server 1404 to serve presentation files. These servers and user devices 1200, 1300 are communicatively coupled to a communications network 1100, such as the Internet by wired and wireless means, or a private network. Additional or fewer devices are provided in varying alternative embodiments. In the example embodiment, no intermediate devices are shown although it is understood that such may be required for relaying communications over the network.

FIG. 1b illustrates a network architecture according to an example embodiment. In the example embodiment a client can communicate to the servers directly through the network, with the exception of a converter, which may seldom or never be contacted directly by contacts since uploading and conversion process updates can be provided by the application server.

In an example embodiment, Browser 10012 can run a system user interface on any HTML5 standard compliant browser. User interface pages can be static and cached on a client device so they can be served efficiently using content delivery network (CDN) services provided by one or more web servers 10002. Application logic can be provided by one or more application message servers 10010. These application message servers 10010 can be replicated as needed to optimize traffic. They can be geographically distributed to reduce message latency and upload and/or download time. The infrastructure can be installed on one or more cloud provider platforms such as Apple, Azure, Google Cloud or others. One or more Proxy/Firewall load balancer web servers 10004 can be used to for one or more of proxy access to a storage module, provide security, caching and load balancing. One or more FileStorage servers 10006 can provide a simple RESTful API for storage of files such as presentations, notes, applications, and other data assets. A queuing system can be used to delivery conversion requests from the one or more Application Message Servers 10010 to one or more HTML conversion servers 10008. The one or more HTML conversion servers 10008 can convert presentations, such as PowerPoint presentations and other file formats, to standard HTML5 presentations that can be viewed on any browser with optimal resolution. This can also make it possible to include interactive objects and fully support animations and transitions, such as those in PowerPoint and other presentation software, as well as the possibility of more advanced animations using Cascading Style Sheets (CSS) and Web Graphics Library (WebGL).

Web pages can be sent over HTTP from one or more web servers 10002 to a web browser 10012 on a client device. Files can be sent back and forth over HTTP from web browser 10012 to one or more Proxy/Firewall Load balancer Web servers 10004. Similarly, messages can be sent back and forth over HTTP from one or more Application Message Servers 10010 to one or more Proxy/Firewall Load balancer Web servers 10004. One or more Proxy/Firewall Load balancer Web servers 10004 can communicate over HTTP with one or more FileStorage servers 10006. One or more HTMLConverter servers 10008 can transmit files over HTTP with one or more FileStorage servers 10006. One or more Application Message Servers 10010 can transmit conversion tasks to one or more HTMLConverter servers 10008 using a command queue. One or more HTMLConverter servers 10008 can transmit messages bi-directionally over Websockets with web browser 10012.

In an example embodiment for embedding objects, objects can be inserted after a presentation has been already converted to HTML5. This embodiment can be used at least for polls, described later herein. Presentation metadata can be stored in a database on storage server 1404. The presentation itself, after conversion to HTML5, can be static and served directly to a client as a series of objects that the clients builds into pages of a presentation. An object can contain a template for the object's dynamic data. Since the presentation is static, the data for a specific presentation session can be stored in the database and assembled by the client for display. Screens used to build polls can be static and part of the client's code, but questions and images can be provided by the presenter and stored in a database, as well as the attendees' replies.

Mobile applications, mobile devices such as smart phones/tablets, application programming interfaces (APIs), databases, load balancers, web applications, page viewers, networking devices such as routers, terminals, gateways, network bridges, switches, hubs, repeaters, protocol converters, bridge routers, proxy servers, firewalls, network address translators, multiplexers, network interface controllers, wireless interface controllers, modems, ISDN terminal adapters, line drivers, wireless access points, cables, servers and others equipment and devices as appropriate to implement the methods and systems herein are contemplated.

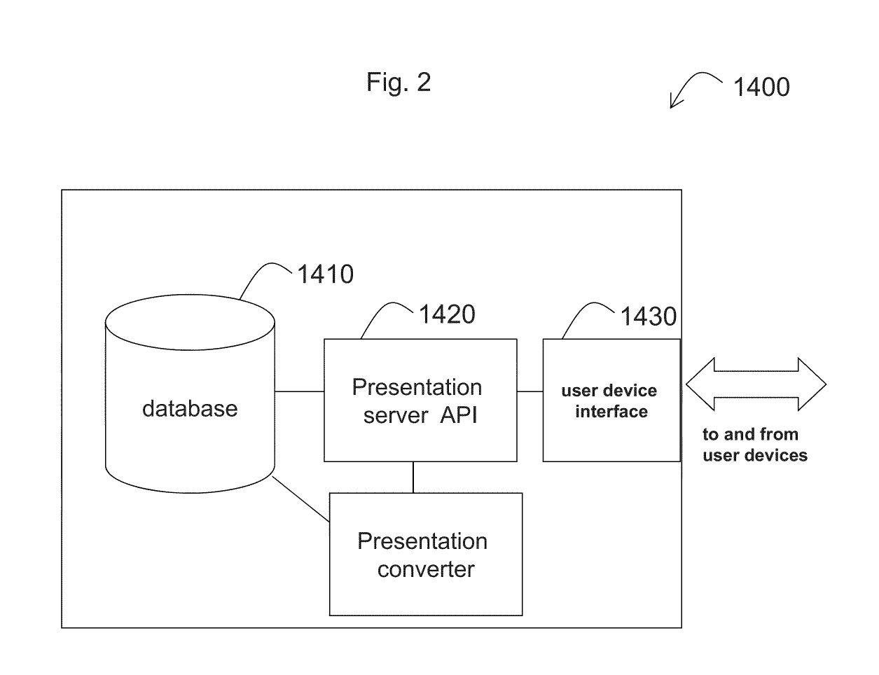

Turning to FIG. 2, an example embodiment of a presentation server 1400 is shown. In the example embodiment a user device interface 1430 is provided for interfacing between external devices and a presentation server API 1420. The presentation server API 1420 is coupled to a database 1410 which can store presentation data, user data, historical data, analytics data, and other data for use in a presentation.

Server systems with multiple servers which may include applications distributed on one or more physical servers, each having one or more processors, memory banks, operating systems, input/output interfaces, and network interfaces, all known in the art, and a plurality of end user devices coupled to a network such as a public network (e.g. the Internet and/or a cellular-based wireless network, or other network) or a private network are contemplated. User devices include, for example, mobile devices (e.g. phones, tablets, or others) desktop or laptop devices, wearable devices (e.g. watches, bracelets, glasses, etc.), other devices with computing capability and network interfaces and so on. The server system can include for example servers operable to interface with websites, webpages, web applications, and others.

In some embodiments, the system can use a presentation server 1400 for direct client access to presentation data. Application databases can store presentation metadata. Presentations can be read-only to both clients and servers and may only be written by a converter when converting the file. The system can identify presentations by a hash generated from a file's data, which allows the system to detect when two users upload identical files and make the second upload to the first one instead of uploading it and converting it again. As a result, multiple users can end up using the same presentation file, even though their metadata will be completely different.

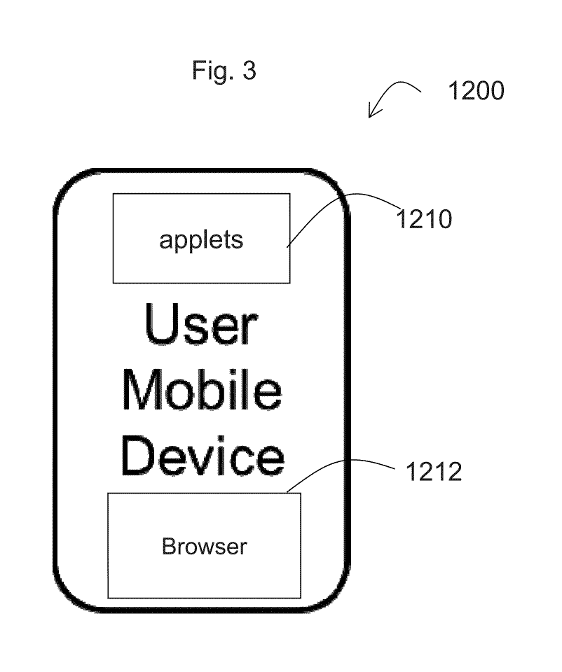

Turning to FIG. 3, an example embodiment of a user mobile device 1200 is shown. In the example embodiment the user mobile device 1200 has a presentation applet 1210 to provide interactive features for the presentation. Mobile device 1200 can also have one or more web browsers 1212.

In an embodiment, the presentation server 1400 takes a presentation file, including but not limited to a PowerPoint or PDF presentation, and converts it to HTML5 for rendering and displaying on a browser on the user device, or client side. The presentation data is then hosted on the presentation server 1400 and provided to users on user devices via a network 1100, for example, the Internet. The converted presentation can run on standard browsers, for example, the users can display the presentation one slide or one page at a time in the browser. The presentation application can take advantage of the flexibility of HTML5, which is constantly being expanded with new features and capabilities. When creating a presentation, for example, a PowerPoint presentation, the presentation server 1400 takes advantage of the software architecture which allows for the inclusion of arbitrary objects in a slide. By developing special PowerPoint objects with HTML5 counterparts, the presentation server 1400 can embed various kinds of advanced interactivity within a slide. For example, PowerPoint allows the presenter to embed a spreadsheet in a slide. By creating an HTML5 spreadsheet object and adding support in the converter, the presentation server 1400 can create a presentation where when tapping on the spreadsheet on the client's slide, the HTML5 spreadsheet viewer will load the spreadsheet data from the presentation server 1400 and allow the user to navigate the spreadsheet locally, change values, draw charts, and so on.

In an embodiment, the presentation server 1400 provides a series of objects that a presenter can embed in a presentation. Objects are architected to allow the presenter to embed all the required data for the objects. When the presenter uploads the presentation to the presentation server 1400, a converter compiles the objects by replacing them with their HTML5 counterparts and making their associated data available online or as part of the presentation. The presentation is stored in the database 1410. The user loads the presentation from the database 1410, which includes the HTML5 for the embedded objects. When the client side renders the presentation, the initial view of the embedded object is shown. If the user interacts with the object (or if the objects has some automatic trigger), the JavaScript in it may start running and provide a special custom behavior to the user. The object may choose to contact the server 1400 to upload interactive data, analytics, and so on. Any local object is cached by the browser at the user device, so logging in after a break or after losing a connection will be faster and more data-efficient.

As an exemplary illustration, a presenter uploads a presentation to the server 1400. A converter pre-processes the presentation. The presentation, for example, a PowerPoint presentation, contains a chart displaying data for smart phone sales, broken by age. The presenter can use PowerPoint's built-in animation capabilities to first show the graph without data, then display the compiled data. An interactive animated object for this slide can take as parameter the data, but asks each user to input what the user thinks the figures are before they are displayed by letting the user drag the bars in the screen. Once the user enters some guesstimates, the object uploads the data to the server 1400. The presenter instance can gather the aggregated data from the server 1400 and shows the research data compared to the interactive data gathered from the audience in real time.

In addition, the data can be stored in a persistent database 1410 viewable long after the live presentation is over, so the next time a user watches the presentation, the data this user provides can be aggregated with the data provided by previous users. The users can write notes, which are stored in the presentation server 1400 and can be downloaded at any time. The presentation server 1400 also keeps a rich history of user interactions in the database 1410.

In an embodiment, the presentation server 1400 may implement web application as a client side database that is synchronized with server side database 1410 using short differential messages.

In an embodiment, the presentation server 1400 includes external extensions to a presentation software, for example, PowerPoint, PDF, and so on, providing a set of objects that can be embedded in a presentation. When an object is embedded, it may require one or more parameters to be specified. The presentation is then compiled to HTML5 by a converter. When one of these objects is found, the compiler replaces the object with an applet and configures it with the parameters' data. When the presentation is viewed by a user in a browser, the applet interacts with the user, for example, polls, and potentially uploads interactive data to the presentation server 1400 and the presenter. This data can be aggregated and displayed as a results screen. As a result, many processing requirements are performed at the user device. For example, the users can use touch gestures to interact with a slide, possibly zooming and panning to see more detail. The presenter's client, at the user device of the presenter, can use the other users' data, aggregate it and display it in various ways. By using embedded objects the presentation platform 1000 allows the presenter to control how and where the interactive features can be placed. The architecture allows for an unlimited amount of possibilities to be created and added later.

An example of an embedded object can be an interactive poll. With an interactive poll, once the system has converted a presentation, it can allow a presenter or other presentation creator to insert special interactive slides for submission of poll data by presentation attendees and for displaying poll results during the presentation. Additionally, the system can provide functionality for adding annotations to slides, which will allow users to include virtual “post it notes,” drawings and text highlights in slides.

In some embodiments, embedded objects can include interactive polls. Once a presentation has been converted, the system can allow a presenter to insert special interactive poll slides for submitting poll data and for displaying poll results. Other embedded objects can include annotation tools, which can allow users to include sticky notes, drawings and text highlights in slides. An embedded object can include a “leave note” object that is inserted in a slide and allows any presentation attendee to add their own note in a list displayed for all attendees when they select the object. Annotation tools can be an additional feature available on a client device that are available for any slide. These features will be described in further detail below.

For interactive polls, client systems can allow presentation attendees to enter data. The data can then be sent to a system server for aggregation and real time results can be delivered to clients for display. Additionally, the system can provide long-life polls. For example, a poll can be included in more than one presentation session and the system can utilize historical data from previous presentation sessions which has been stored in memory. For example, a poll can be used to measure the effectiveness of a presenter and the results can show his or her performance for the current presentation as rated by attendees, historical performance, year to date performance, and other metrics as calculated by the system based on data received from attendees.

To elaborate, in some poll embodiments, clients can allow attendees to enter data. The data is can then be transmitted to a system server for aggregation and real time results can be delivered to one or more clients for display. The system can also provide for long-life polls. For example, a poll can be included in more than one session or presentation, and the system can allow presenters to utilize data from previous sessions. For example, a poll can be used to measure the effectiveness of the presenter, and the results could show his/her performance for the current presentation and year to date performance.

In annotation embodiments, data can be collected on the client side (e.g. an attendee using tools to draw on the screen and take notes) and then the data can be stored on the server and associated with a user's identification and session information for which the notes were entered. The attendee can later access the information and also email the presentation to himself using system tools which can, in some embodiments, convert the presentation format.

Some features disclosed herein are part of a client's code and other features are embedded objects with their own code, which can generate their own data by interacting with the attendee. For example, for polls the system can extend the application's UI to provide the functionality. This can enhance interactivity, as attendees interact with the system and provide data, which is then aggregated and shown.

Polls can be implemented as a separate client-server system that include one or more embedded objects inserted by the presenter into a presentation slide. When a user loads the slide, the object can load itself and provide its own interactive UI, which can potentially be independent from system servers. For example, it can be developed by a third party.

For annotations, data regarding presentation attendee interaction can be received and stored on the client side. For example the attendee using system tools to draw on the screen, take notes, or otherwise interact with the presentation. This data can then be transmitted and stored on a server, including reference information used to associate the data with an attendee's identity and a session identity for which the notes or other interactions were captured. The attendee can email the presentation to himself or access the presentation from the server at a later time for review.

In an embodiment, the presentation platform includes the ability to geographically install messaging servers and to have those servers immediately partition data traffic so that traffic from user stay on a local “subnet”.

The example embodiments described above generally relate to an interactive presentation with the systems and methods described herein. It should be understood that in other embodiments, additional browser languages and presentation software can be used. In addition to the exemplary objects described herein, other supported objects may include, but are not limited to, GIFs, animations, transitions, links, video, audio, and so on. The combinations of user devices, browser languages and presentation software are numerous and modules, displays, and other tools described herein can be specific or centralized on a particular device in some embodiments while in other embodiments they can be distributed over multiple devices including standalone networks.

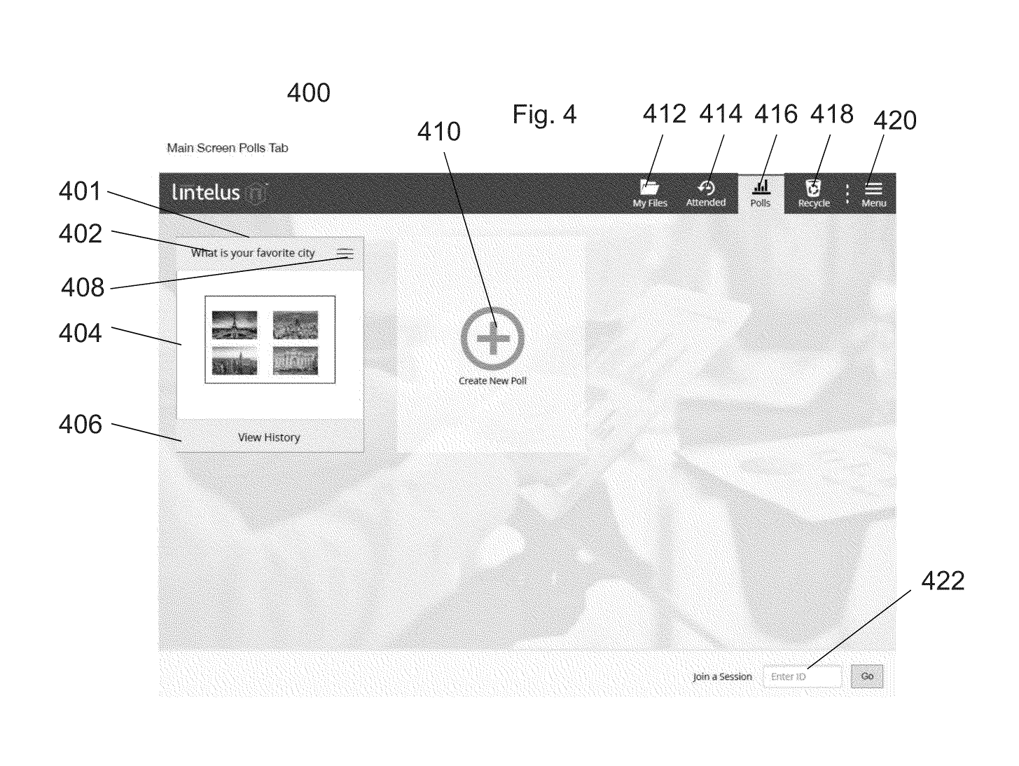

FIG. 4 illustrates an example embodiment of a user interface showing a main screen 400 with a poll tab 416. Poll tab 416 can allow users to view previously created polls and create new polls. In the example embodiment, a poll 401 can include a poll title 402, poll answer preview 404, poll history 406, and poll interaction menu 408. A poll creation field 410 can allow a user to create a new poll. Various system fields include my files 412, attended 414, recycle 418, system menu 420 and session id entry field 422.

Poll 401 can include information for a poll a user has previously created, downloaded, received, uploaded or otherwise acquired. Polls can be singular in nature in some embodiments while in other embodiments may have multiple subparts. A poll title 402 can be a specific name of a poll or can simply be a short synopsis of the poll question, inquiry, prompt, call or discussion point. A poll answer preview 404 can include a brief preview of the poll answer choices which can be in the form of a miniaturized version of the answers. A poll history 406 can be a button allowing users to view historical information relating to the poll. This can take many forms, including when the poll was administered, results of the poll, how often the poll has been administered and other pertinent information. Poll interaction menu 408 can allow users to interact with the poll, including editing the poll. Poll creation field 410 can be a user selectable field allowing users to create a new poll from scratch.

My files 412 can be a user selectable field allowing users to view and load user files. An attended 414 button can allow a user to view pertinent attendance information including polls attended, dates, times, interaction information, list of others attending, and other information. A recycle 418 button can allow a user to delete polls. System menu 420 can allow users to view system tools. Session id entry field 422 can allow users to quickly navigate to a particular presentation session if the user enters a valid code as confirmed by system processors against a database.

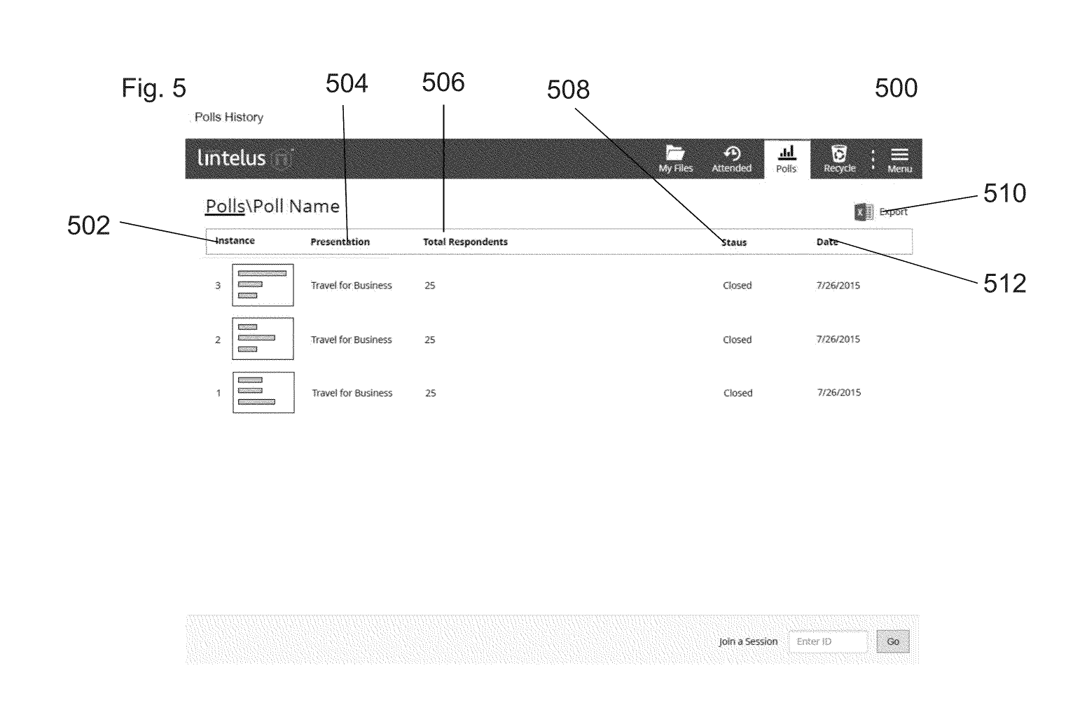

FIG. 5 illustrates an example embodiment of a user interface showing a polls history page 500. In the example embodiment, a poll instance 502 can include information about how often a poll has been conducted. A presentation name 504 can include information about which presentation a poll has been included in. A total respondents column 506 can include the total number of people to participate or respond to a poll. A status column 508 can indicate whether a poll is open, closed, or how long a poll has before expiring. A date column 512 can include information regarding when the poll was administered. An export button 510 can allow a user to export poll history results to another program, such as a database program. In some embodiments this can include converting into a different format while in other embodiments it can include opening results in a third party program.

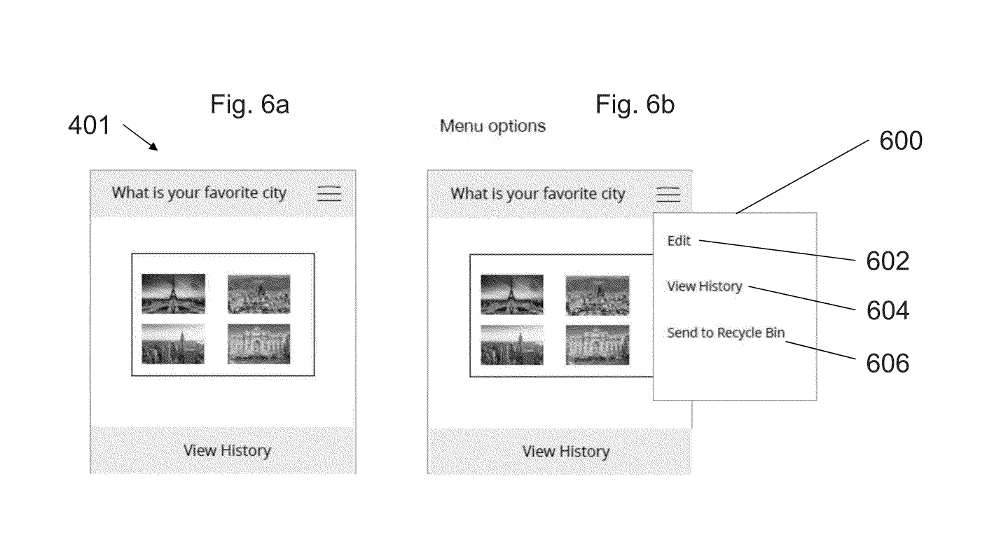

FIG. 6a illustrates an example embodiment of a user interface showing a polls history window 401 with features as described with respect to FIG. 4 above.

FIG. 6b illustrates an example embodiment of a user interface showing a polls history window with menu 600. A menu can include edit button 602, view history button 604, send to recycle bin button 606 and others, as appropriate. An edit button 602 can allow a user to edit a poll. A view history button 604 can allow a user to view a poll history. A send to recycle bin button 606 can allow a user to delete the poll. In some embodiments a user can recover a poll at a later point by opening a recycle bin and selecting an option to recover.

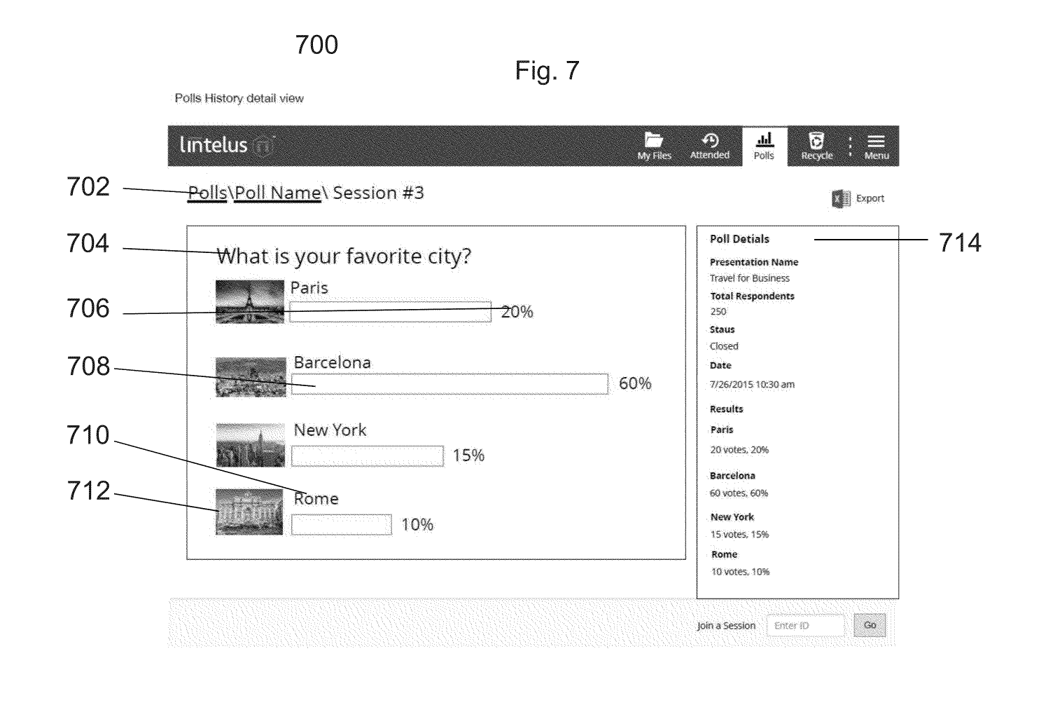

FIG. 7 illustrates an example embodiment of a user interface showing a polls history detail view 700. In the example embodiment an identifier area 702 can include a poll name, location, or both. As shown, a location includes a file path of “polls,” “poll name,” and “session #3.” A poll question or prompt 704 can include the call of the poll. Here, the call is “What is your favorite city?” Answer choices 710 can include written description of answers. Here, answer choices can include Paris, Barcelona, New York and Rome. A graphical representation 708 can include a graphical representation of how many poll responders have selected a particular answer choice. Here, they are bar charts representing a number for each of the associated answer choices. In other embodiments they may include pie charts, graphs or other graphical representations. A quantifier 706 can include a quantity of responders who chose each answer for a poll. Here, these are represented as percentages including 20%, 60%, 15%, and 10%. In other embodiments they may be real numbers of responders such as 17, 452, or others. An answer choice image 712 can be an image associated with each choice. Here, landmarks from each city are shown as associated with answer choices 710. Poll details field 714 can include detailed information regarding the poll. In the example embodiment poll details are shown as Presentation Name—Travel for Business, Total respondents—250, Status—closed, Date—Jul. 26, 2015 10:30 am. Additionally included in poll details field are Results information including a number of votes for each answer choice.

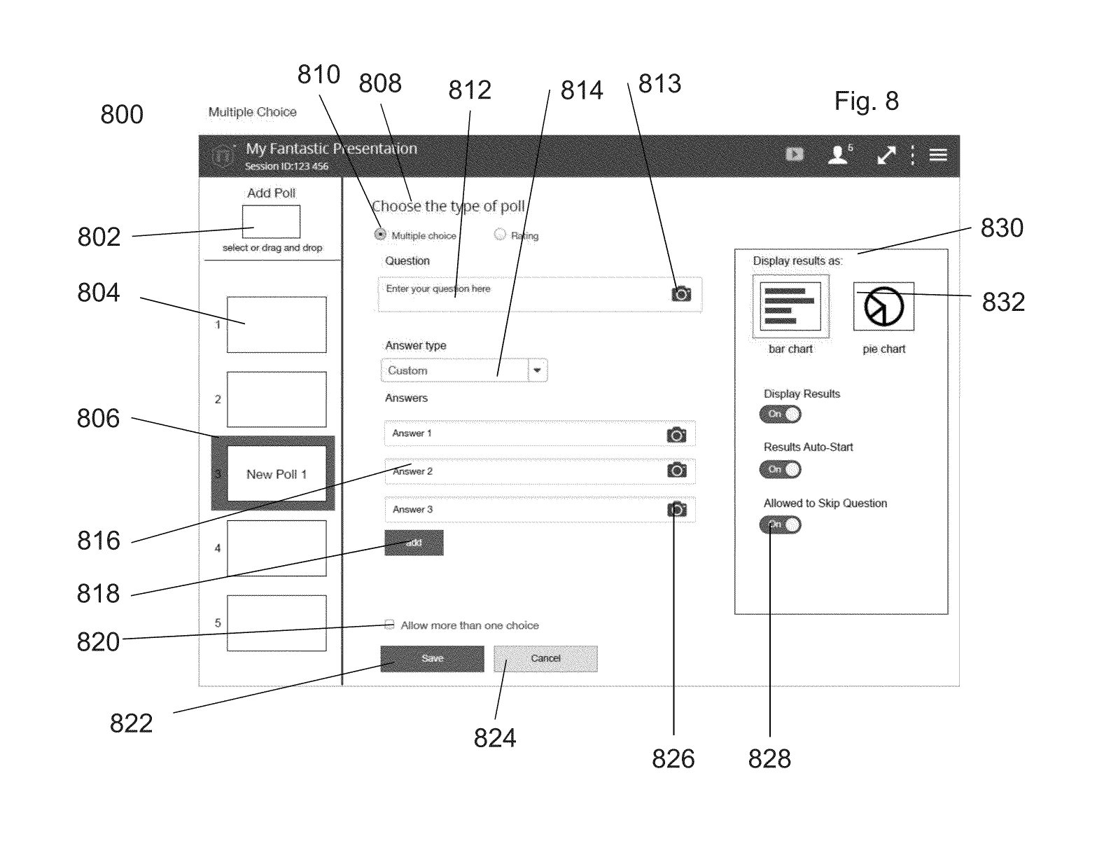

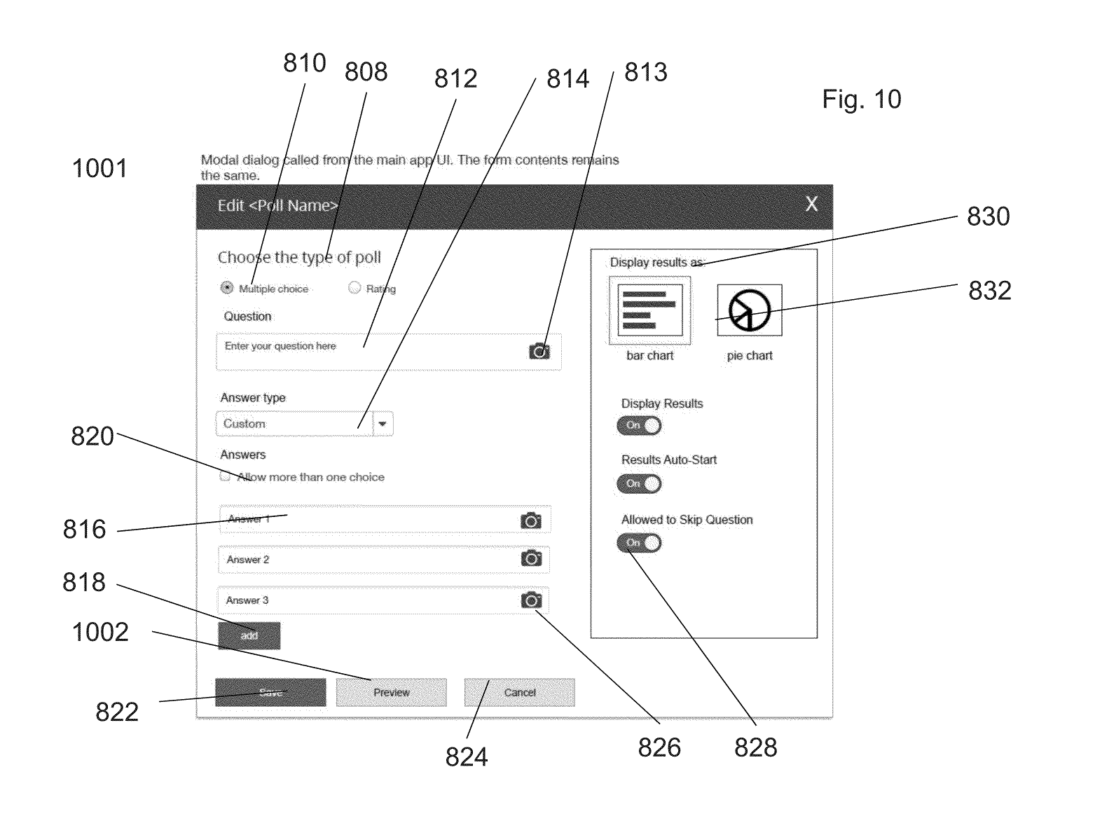

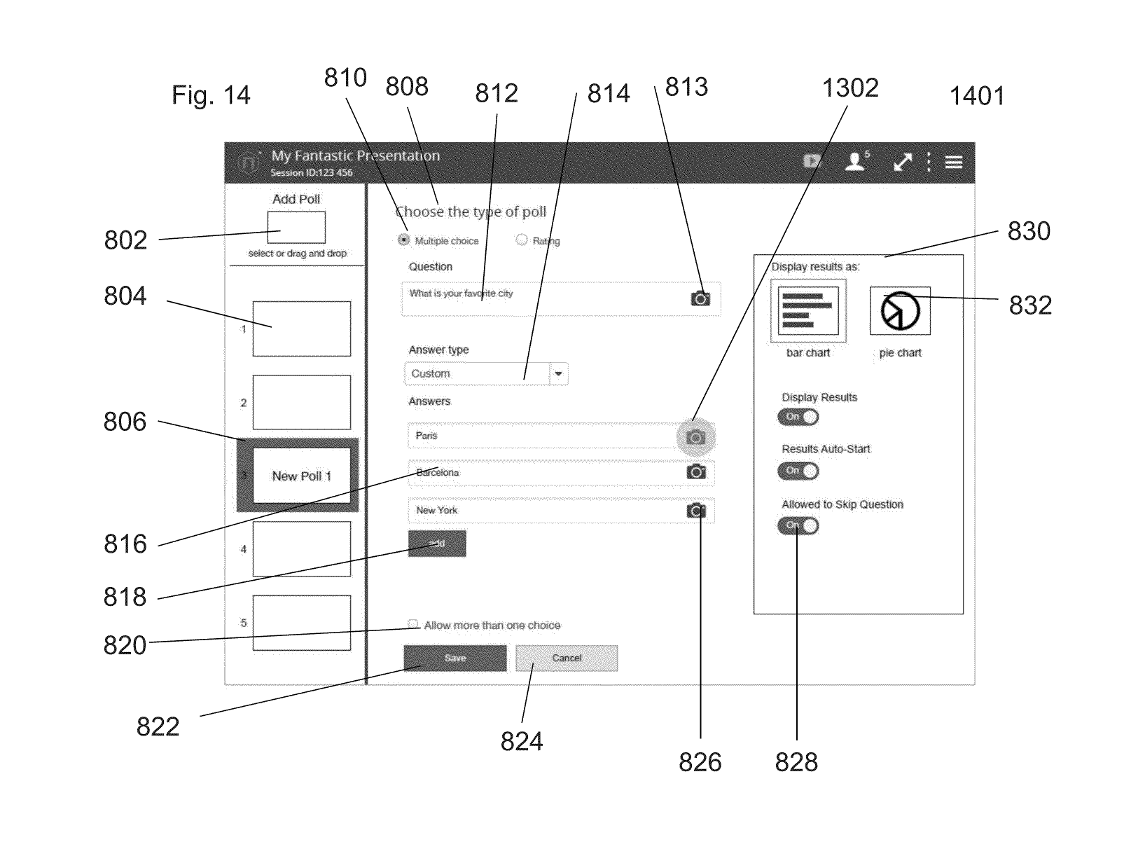

FIG. 8 illustrates an example embodiment of a user interface showing a multiple choice poll creation page 800. In the example embodiment, a user can add a poll by selecting button 802 or dragging poll button 802 to a location in a slide group such as location 804, representing a first slide. A current selection indicator 806 can indicate which slide a user is currently editing. Here, this is represented by a halo outline although various other indicators can be used such as check boxes, magnified or enlarged slide indicators or others. An instruction area 808 can show system instructions for users including “Choose the type of poll” and others. Radio buttons 810 can allow a user to select which type of poll they wish to create. Here, a multiple choice poll is selected. Radio buttons 810 can also be different in different formats such as a drop down menu, sliders or others. A question or prompt field 812 allows a user to type, paste, or otherwise include a question or prompt for the poll. Additionally, a poll prompt image button 813 can allow a user to choose an image stored on a computer, downloaded from a network or otherwise uploaded from memory to include in a poll prompt. An answer type menu 814 can allow a user to choose answer types they wish for responders to choose from. Answer choice fields 816 can allow a user to enter, paste or otherwise select answers to the prompt. Answer image buttons 826 can allow a user to include images for one or more of the answer choices. An add button 818 can allow a user to add additional answer choices. A remove button (not shown) can allow a user to remove answer choices. A poll modifier button 820 can allow users to customize respondents answer abilities. Here the poll modifier button 820 allows users to allow more than one answer if selected. Other options are contemplated including allow a specific number of answers per respondent. A save button 822 allows a user to save the current poll edits. A cancel button 824 allows a user to cancel all edits to a current poll. A results display choice field 830 can allow a user to customize display results. In the example embodiment this includes choice of results display buttons 832 such as bar chart or pie chart. Results modification sliders 828 can allow a user to turn various results options on, off, or scaled in some embodiments. Here, a user can choose to modify one or more of “display results,” “results auto-start,” and “allow to skip question” by sliding the results modification sliders 828 to on or off positions. With display results off, results will not be shown publicly once the poll is completed. With results auto-start on, results will be calculated by a processor as soon as every respondent has responded or a timer has run out. Allowed to skip question in the on position will allow respondents to not answer questions if they choose not to. FIG. 10 illustrates another example embodiment of a user interface showing a poll editing page 1001. Here, poll editing page 1001 is a selection window allowing users to edit as described above. A preview button 1002 can allow a user to view a poll preview before saving a poll. FIG. 14 illustrates an example embodiment of a user interface showing image additions 1401 to a poll with a highlight indicator 1302. Highlight indicator 1302 can draw a user's attention to a particular area of the screen, improving a user's efficiency.

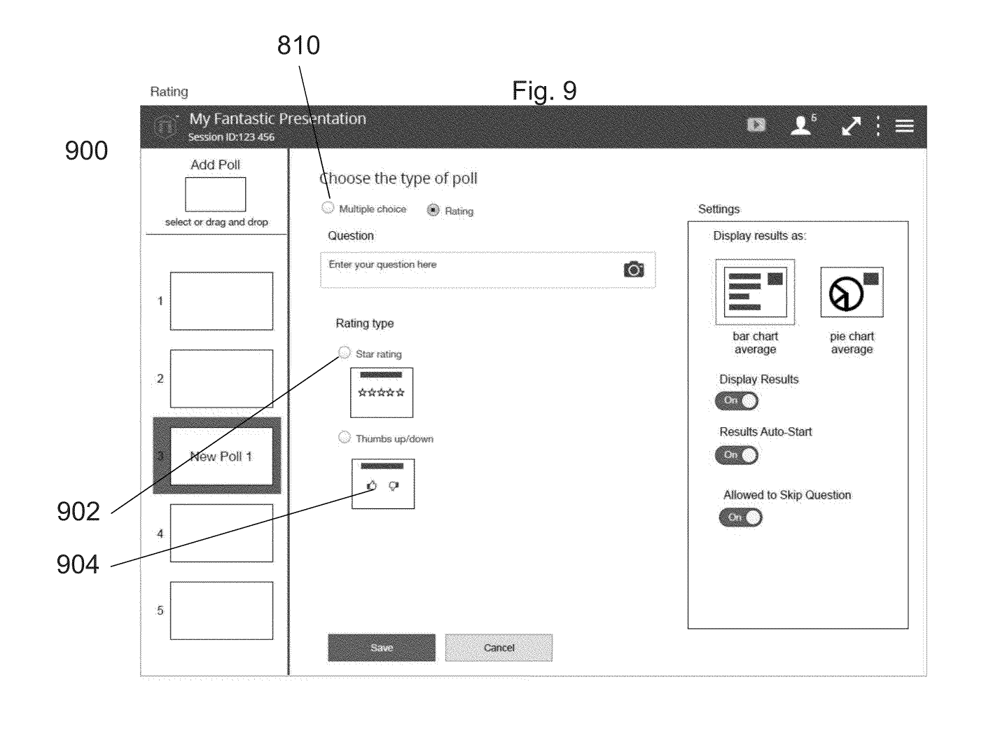

FIG. 9 illustrates an example embodiment of a user interface showing a poll rating page 900. In the example embodiment, radio buttons 810 can allow a user to select which type of poll they wish to create. Here, a rating poll is selected. Rating type radio buttons 902 can allow a user to choose what type of rating they wish to allow respondents to make. Options shown are star rating and thumbs up/thumbs down rating. Rating type previews 904 show graphical representations to the user of what the rating types will look like when displayed to respondents.

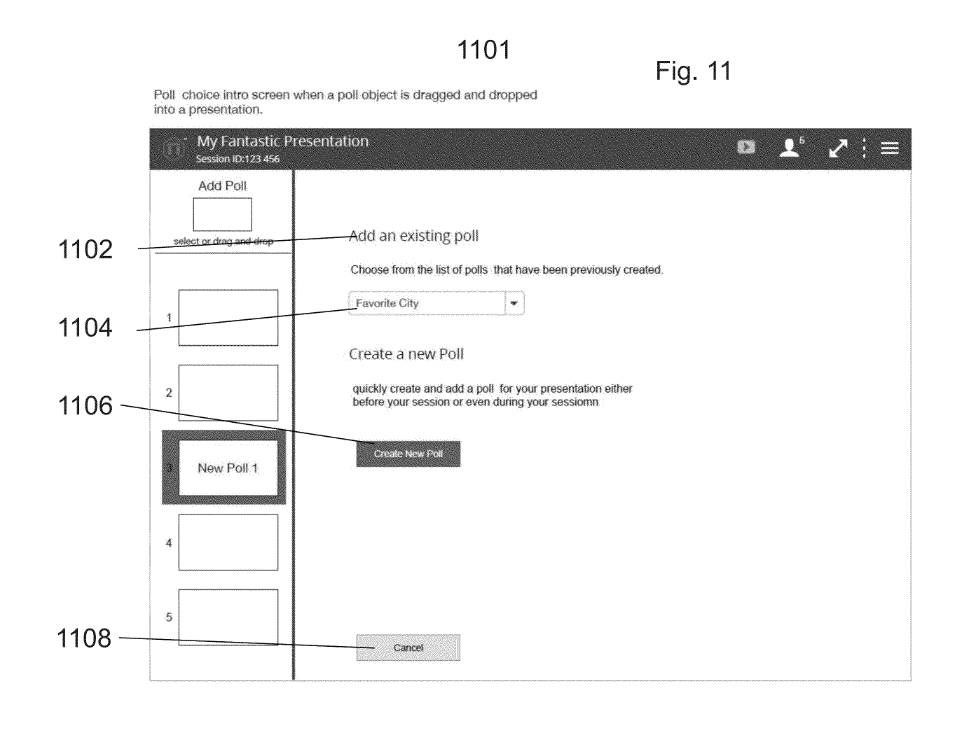

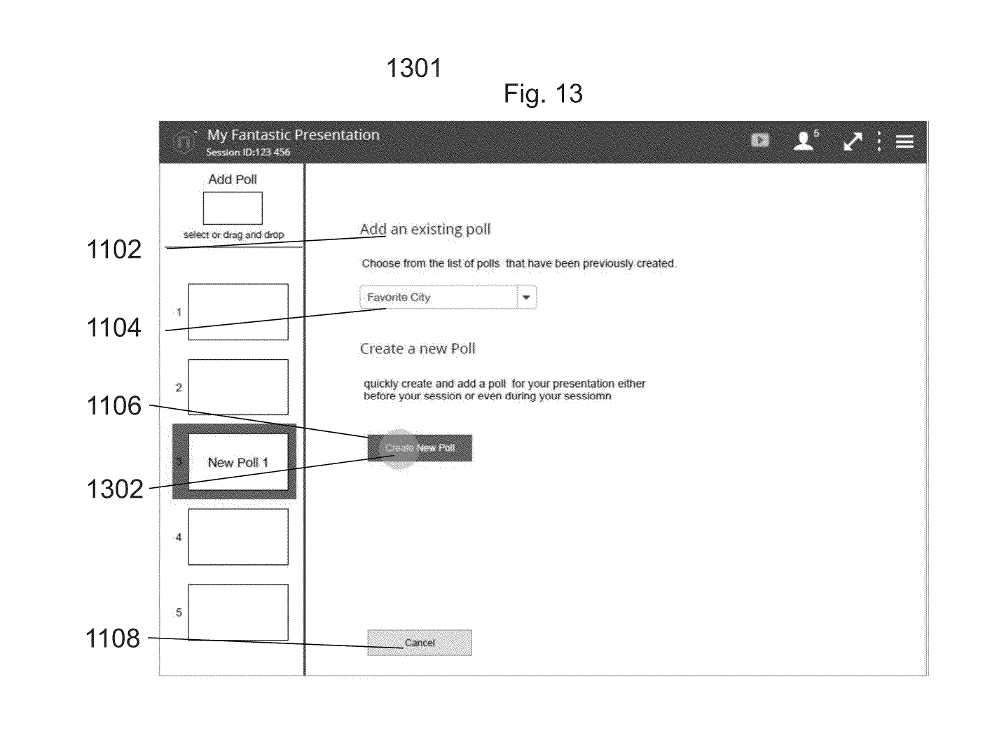

FIG. 11 illustrates an example embodiment of a user interface poll choice intro screen 1101 showing a poll object added to a presentation. In the example embodiment the poll choice intro screen 1101 can be displayed when a poll object is dragged and dropped into a presentation. Non-interactive instructions 1102 can be displayed in numerous locations on the screen. Here, instructions 1102 include “Add an existing poll,” “Choose from the list of polls that have been previously created,” “Create a new poll,” and “quickly create and add a poll for your presentation either before your session or even during your session.” A previously created poll selection field 1104 can be a drop down menu with names of previously created polls that are stored in memory by the system. In other embodiments field 1104 can include radio buttons next to choices, buttons which create a pop-up window, or others as appropriate. A create new poll button 1106 can create a new poll which allows users to start a new poll from a beginning step. A cancel button 1108 allows a user to exit the current screen. FIG. 13 illustrates another example embodiment of a user interface showing a poll creation screen 1301 with poll creation button 1106 with a highlight indicator 1302. Highlight indicator 1302 can draw a user's attention to a particular area of the screen, improving a user's efficiency. In some embodiments, highlight indicator 1302 can be implemented in a training program for the system to help teach users how to use the system efficiently.

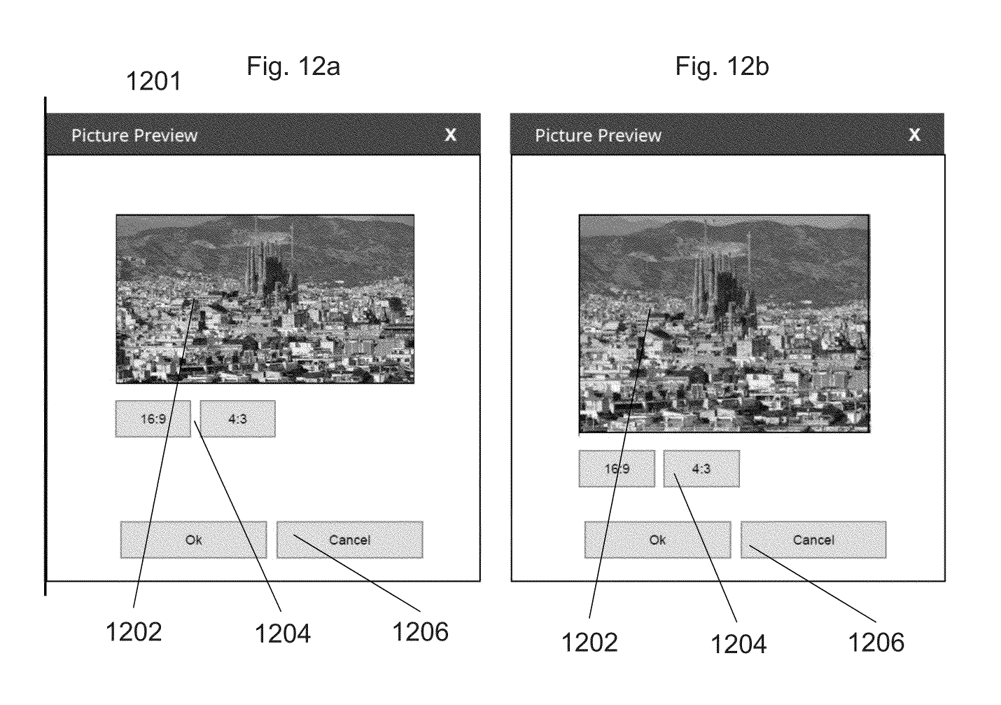

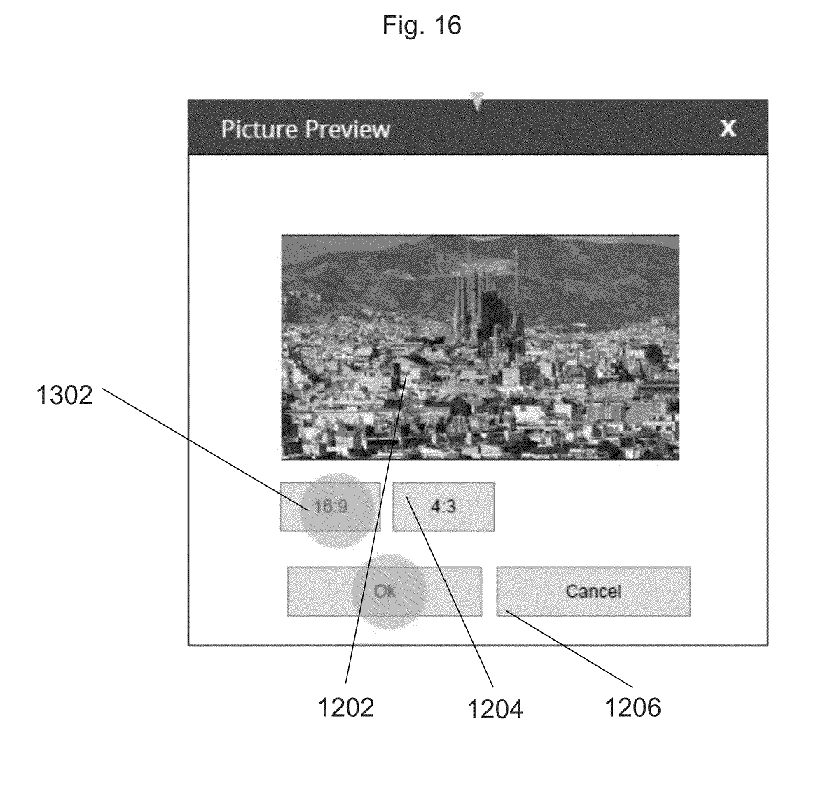

FIG. 12a illustrates an example embodiment of a user interface showing a picture preview 1201 with a first size. FIG. 12b illustrates an example embodiment of a user interface showing a picture preview 1201 with a second size. In the example embodiments a picture preview 1202 shows an image which the user has previously selected to include in a poll. Aspect ratio buttons 1204 allow a user to select an aspect ratio for the selected picture. Here, choices include 16:9 and 4:3 although many others can be included in the system. Decision buttons 1206 can include “OK,” “Cancel,” or others. FIG. 16 illustrates an example embodiment of a user interface showing picture preview selection 1600 with highlight indicators 1302.

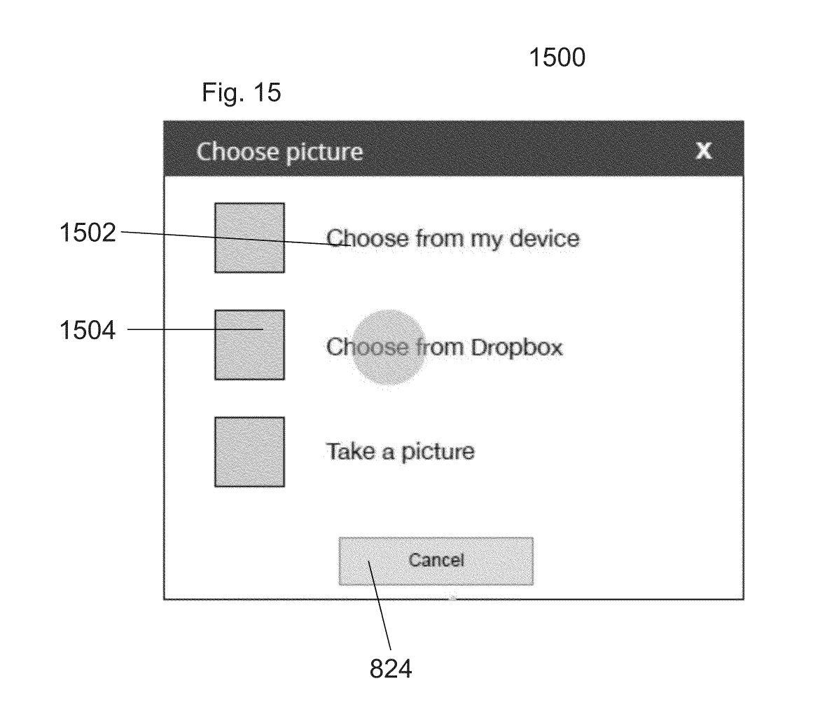

FIG. 15 illustrates an example embodiment of a user interface showing picture selection window 1500, allowing a user to choose a picture from a variety of sources 1502. Sources 1502 can include “Choose from my device,” “Choose from Dropbox,” “Take a picture,” or others. Interaction buttons 1504 allow a user to make an associated selection.

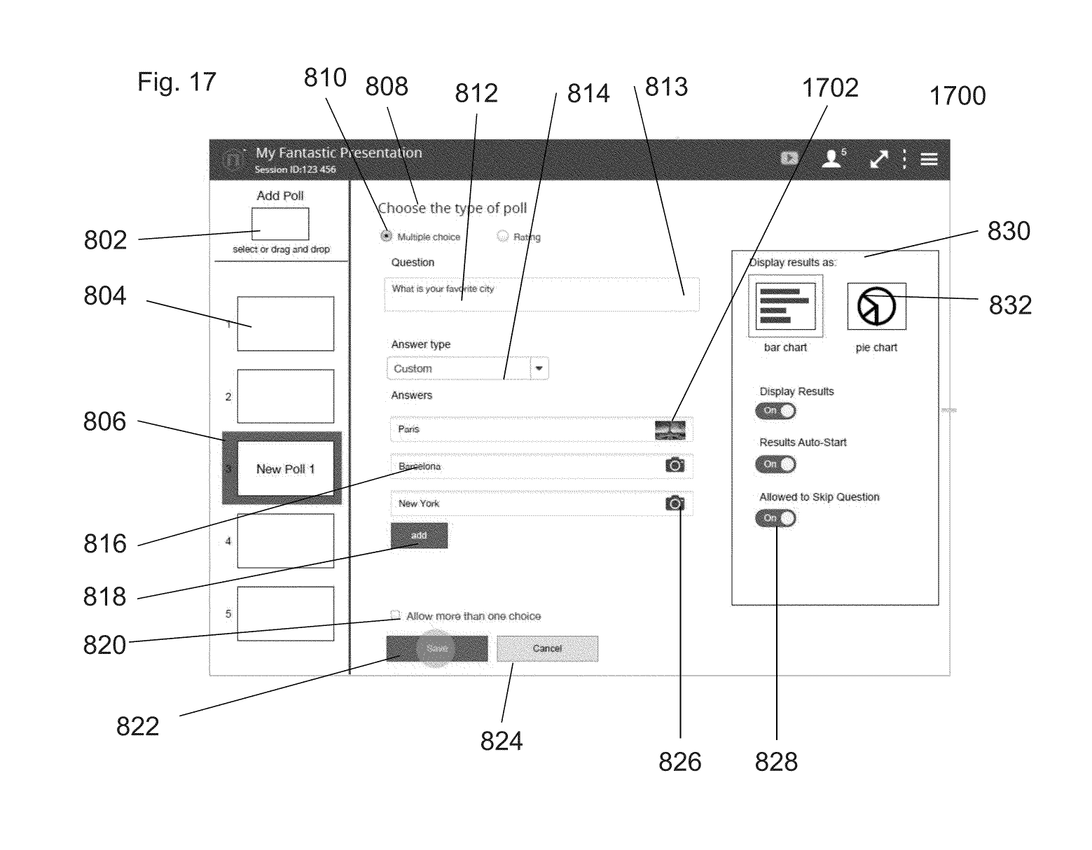

FIG. 17 illustrates an example embodiment of a user interface showing a poll saving screen 1700. In the example embodiment, a user has selected an image to be associated with answer choice 816 “Paris” and a thumbnail 1702 shows the image in a small preview.

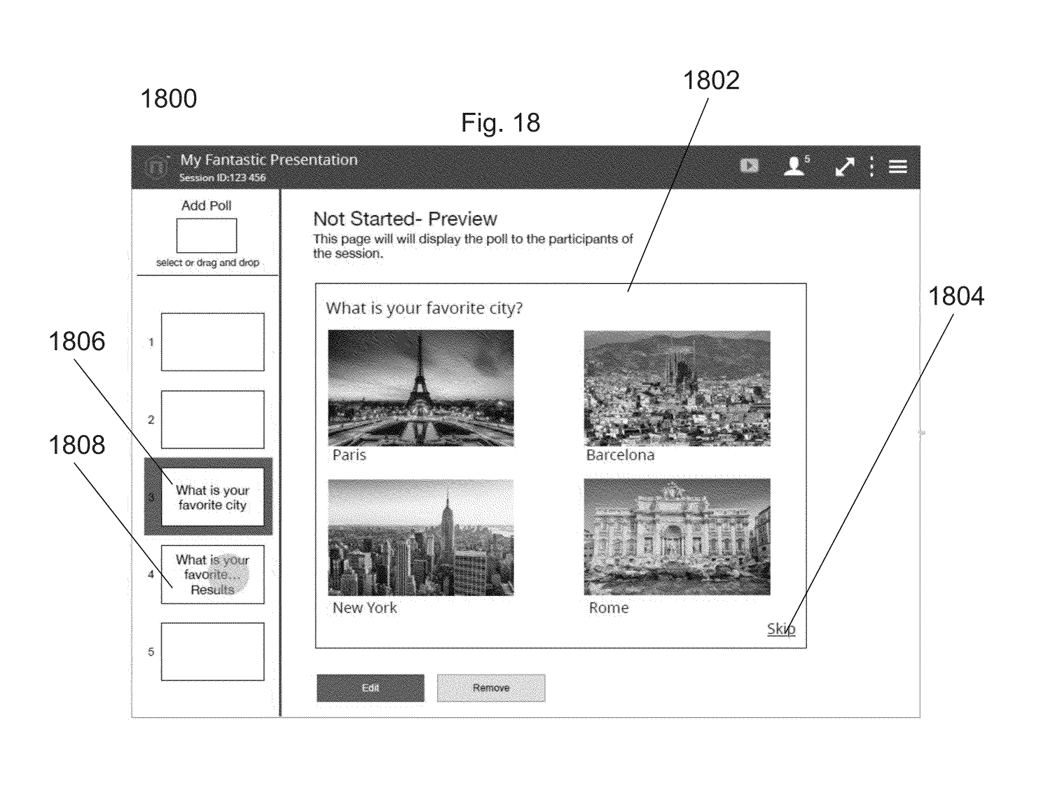

FIG. 18 illustrates an example embodiment of a user interface showing a poll preview page 1800. In the example embodiment a poll preview 1802 can display a poll in a presentation to a user before it is displayed for respondents. A skip button 1804 can allow the user to skip the poll during the presentation if the user wishes. For example, if the presentation is short on time then a user may not wish to include the poll in a current presentation and can select the skip button 1804 to move on to a next slide. Poll slide 1806 and results slide 1808 show that a user can change slide order as desired in a presentation. For example, a user may wish to take a poll, by displaying a poll slide 1806 and then present an informational slide before displaying a results slide 1808. As such, a drag and drop or copy and paste operation can allow the user to move slides around as desired.

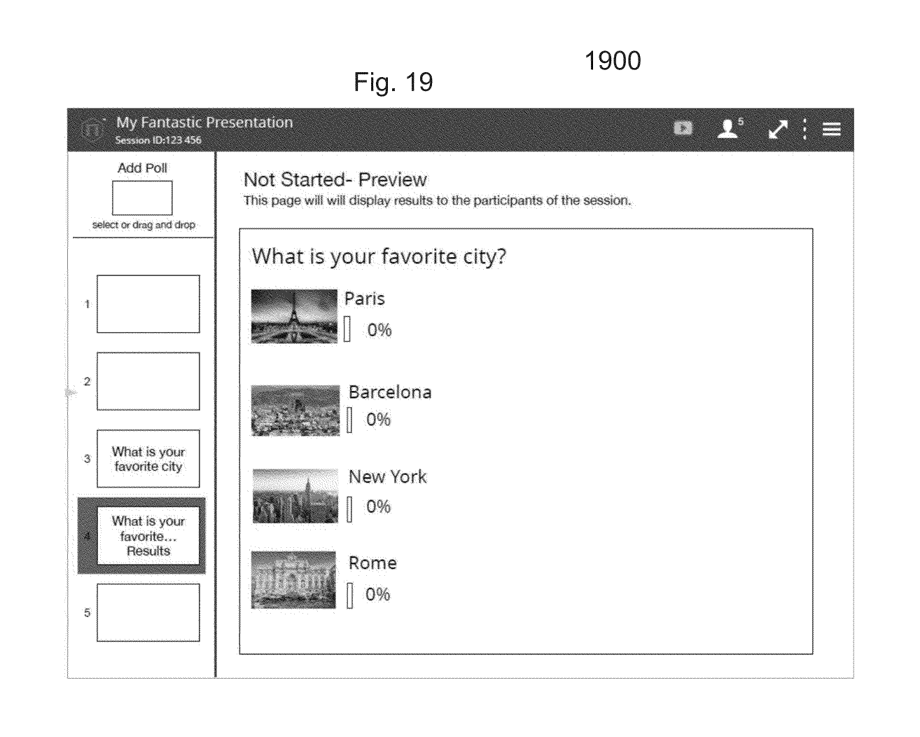

FIG. 19 illustrates an example embodiment of a user interface showing a poll results preview page 1900. This can be useful for users who wish to view how a results slide will appear to respondents.

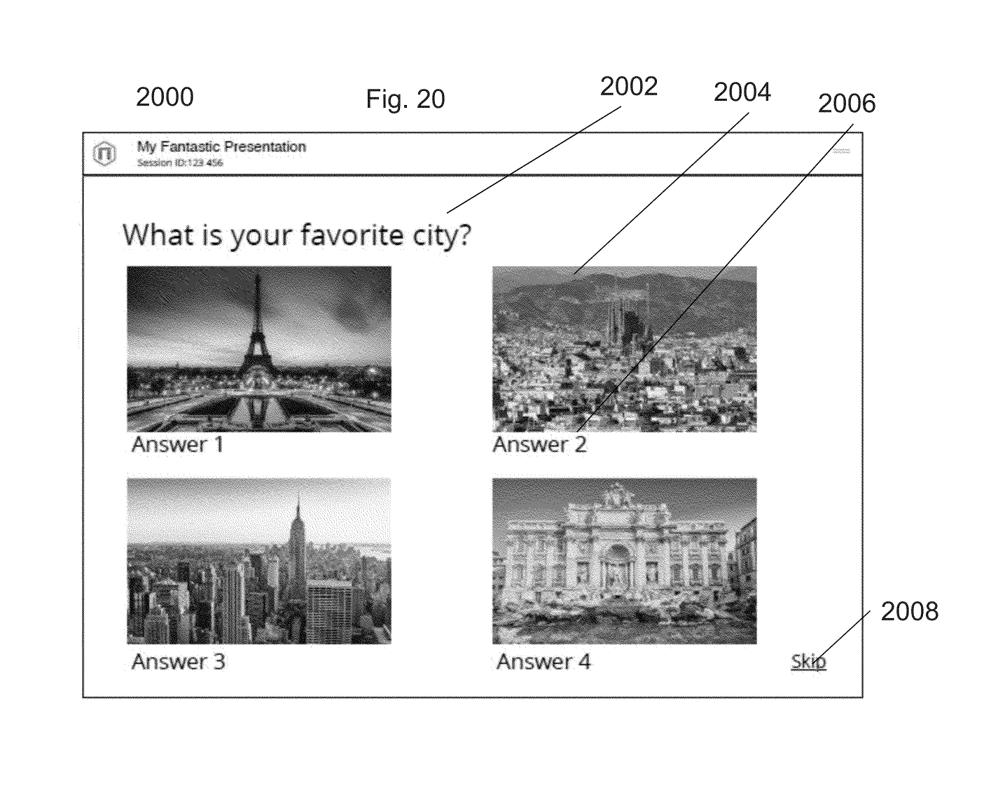

FIG. 20 illustrates an example embodiment of a user interface showing a poll participant display 2000. In the example embodiment a respondent can view a poll question or prompt 2002, images 2004 and choice descriptions 2006. A respondent can also choose to select a skip button 2008 if they choose not to answer the question. Choosing the skip button 2008 may go to a next slide or may delay respondent's viewing of the next slide depending on system settings.

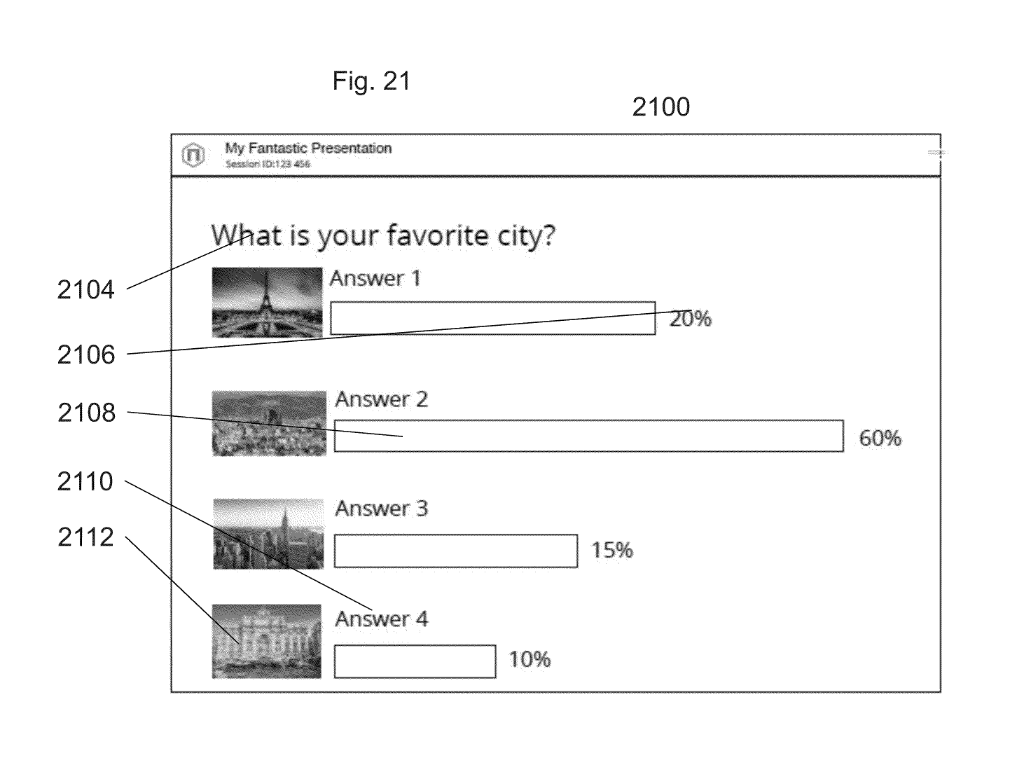

FIG. 21 illustrates an example embodiment of a user interface showing a poll results page 2100. In the example embodiment, a poll question or prompt 2104 can include the call of the poll. Here, the call is “What is your favorite city?” Answer choices 2110 can include written description of answers. A graphical representation 2108 can include a graphical representation of how many poll responders have selected a particular answer choice. Here, they are bar charts representing a number for each of the associated answer choices. In other embodiments they may include pie charts, graphs or other graphical representations. A quantifier 2106 can include a quantity of responders who chose each answer for a poll. Here, these are represented as percentages including 20%, 60%, 15%, and 10%. In other embodiments they may be real numbers of responders such as 17, 452, or others. An answer choice image 2112 can be an image associated with each answer choice 2110. Here, landmarks from each city are shown as associated with answer choices 2110.

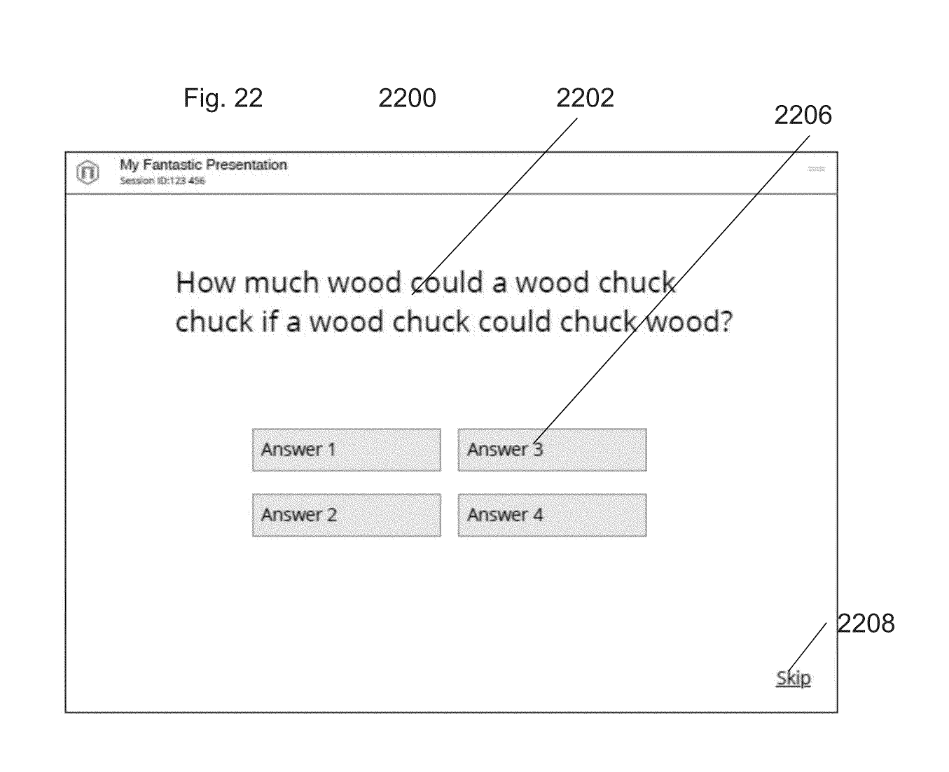

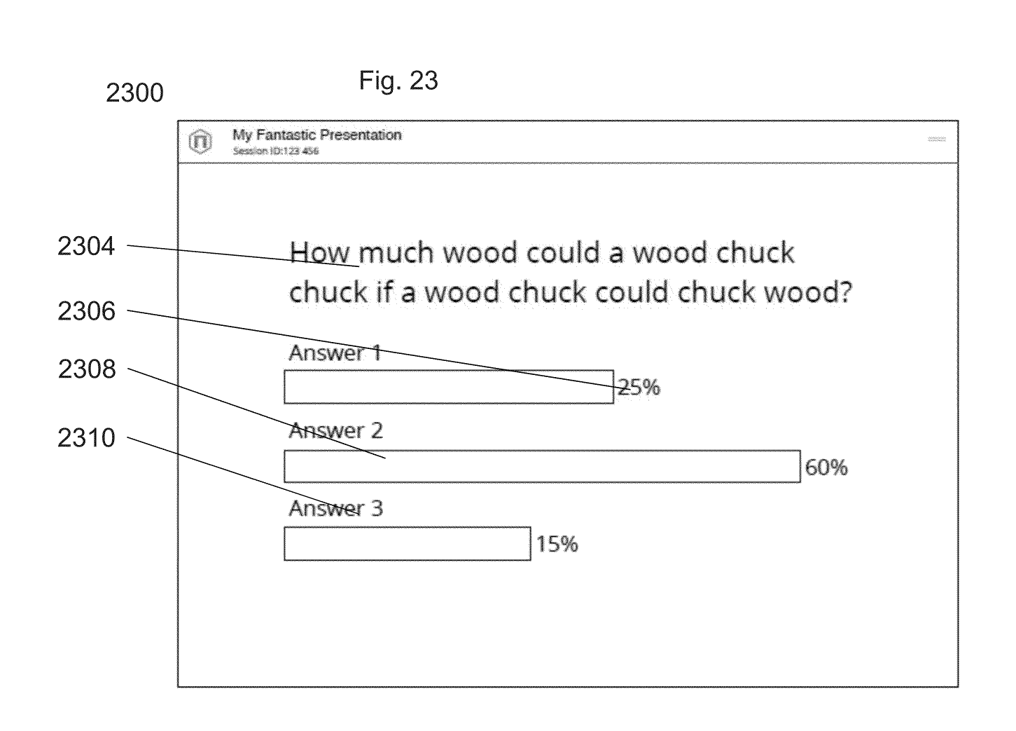

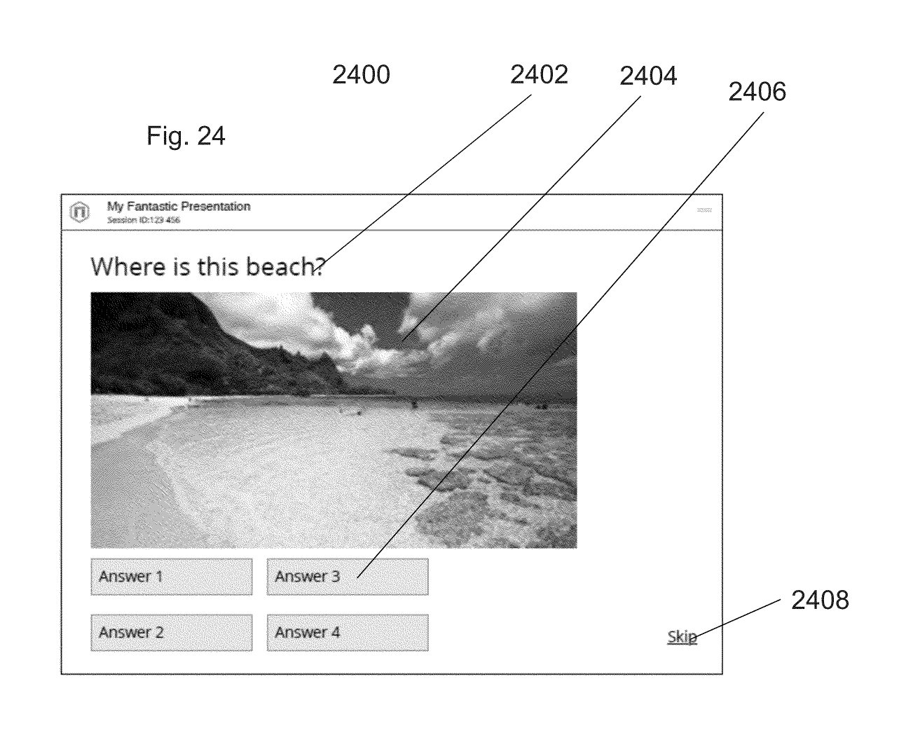

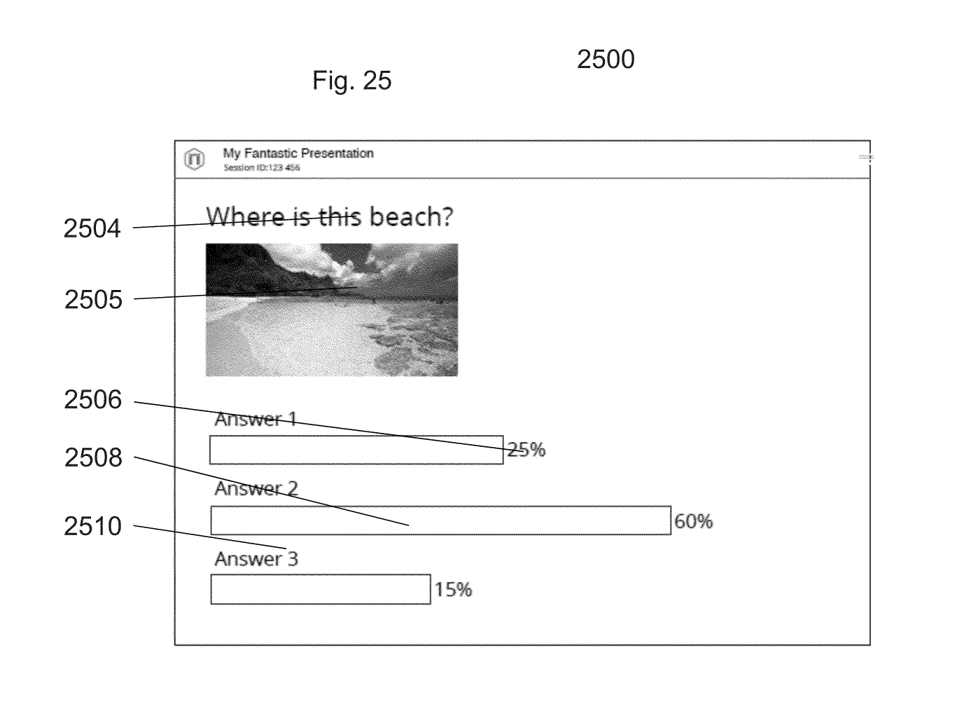

FIG. 22 illustrates an example embodiment of a user interface showing a poll question page 2200. In the example embodiment, a respondent can view a poll question or prompt 2202, and choice descriptions 2206. A respondent can also choose to select a skip button 2208 if they choose not to answer the question. Choosing the skip button 2208 may go to a next slide or may delay respondent's viewing of the next slide depending on system settings.

FIG. 23 illustrates an example embodiment of a user interface showing a poll answer results page 2300. In the example embodiment, a poll question or prompt 2304 can include the call of the poll. Here, the call is “How much wood could a wood chuck chuck if a wood chuck could chuck wood?” Answer choices 2310 can include written description of answers. A graphical representation 2308 can include a graphical representation of how many poll responders have selected a particular answer choice. Here, they are bar charts representing a number for each of the associated answer choices 2310. In other embodiments they may include pie charts, graphs or other graphical representations. A quantifier 2306 can include a quantity of responders who chose each answer for a poll. Here, these are represented as percentages including 25%, 60%, and 15%. In other embodiments they may be real numbers of responders such as 17, 452, or others.

FIG. 24 illustrates an example embodiment of a user interface 2400 showing a combined poll prompt 2402 with image 2404 and answers 2406. Also included is a skip button 2408.

FIG. 25 illustrates an example embodiment of a user interface showing a poll results page 2500. Prompt 2504, image 2505, quantifier 2506, graphical representation 2508, and answer choice descriptions 2510 are shown and are similar to the descriptions provided previously.

FIG. 26 illustrates an example embodiment of a user interface showing an interaction screen 2600. In an example embodiment, the system can provide slide annotation tools for users in a menu 2602 including a drawing tool such as a pen, highlighter, eraser, and erase all. Also included are “sticky” notes 2604. Users can select unique colors by choosing from a color menu. 2604 including Hack, white, blue, green, orange, yellow, red, violet, or others as appropriate. Selecting an icon can activate it while selecting it a second time without selecting another icon can deactivate the currently selected icon. In some embodiments, user interactive shared whiteboards can be implemented, allowing multiple users to edit the same slide which can be displayed in a presentation.

FIG. 27a illustrates an example embodiment of a user interface showing a variety of menus and tools. A user can select a tool by clicking it and then optionally selecting a color other than a default color. Menu displays 2702, 2704, 2706, 2714 all show different layouts with tools. Pen and Highlighter tools can have the following operability. The user can then move a cursor (not shown over a presentation (shown in the background in FIG. 26) and move the icon around while using the tool, for instance by holding down a mouse button operably connected with a computer or dragging a finger across a touchscreen tablet in order to draw marks on the presentation. The marks can be limited to the single slide currently displayed and if a user strays or otherwise attempts to mark outside of the currently displayed slide, the stray marks will not be recorded or displayed. Marks 2712 show highlighter movements across a screen.

Eraser tools can have the Mowing operability. A user can select the eraser tool and similar to the pen and highlighter operation, drag an icon around the screen which, in some embodiments is adjustable in size. In some embodiments, single operation operability allows a user to select a pen or highlighter stroke merely once to erase an entire mark which could stretch across a slide. As such, the entire object can be erased. An erase all tool can allow a user to erase all markings on a slide or all markings in a presentation and in many embodiments this will prompt a popup window asking the user to confirm that they wish to truly erase all marks.

FIG. 27b illustrates an example embodiment of a user interface showing an unmarked slide. FIG. 27c illustrates an example embodiment of a user interface showing a marked slide. In the example embodiment a user has highlighted 2702, used a pen tool to circle area 2704 and introduced speaker notes in the form of sticky notes 2706.

FIGS. 28a-28h illustrate example embodiments of various sticky note functions. Sticky Notes can be displayed under headers in many embodiments. Sticky note tools can have the following operability. A user can select a sticky note button 2606 (as shown in FIG. 26) and optionally select a color from a sticky note color palette. In some embodiments this sticky note color palette can be the same as one provided for pens and highlighters while in other embodiments it may be unique. Sticky notes can be numerically or alphabetically ordered 2812 (as shown in FIG. 28c) such that a user can easily reference them at a later time. In some embodiments a user can delete a sticky note which may leave a void in an otherwise normal numerical sequence. For example, for sequence 1, 2, 3, 4, 5, if a user deletes sticky note 3, this will not cause an automatic renumbering of the sticky notes but rather leave 1, 2, 4, 5. This can assist users in maintaining consistency. In some embodiments, if a user deletes a most recent sticky, the system can remember the deleted number but still advance to the next number. For example, if a sequence is 1, 2, 3, 4, 5 and a user deletes slide 5 but proceeds to add another sticky note, the sequence will pick up at 6 such that the sequence will be 1, 2, 3, 4, 6. In many embodiments users can interact with sticky notes at any time. Interacting with a sticky note can include selecting a top left toggle between a collapsed and displayed mode. Selecting an “x” 2806 as shown in FIG. 28b when a sticky note is in an expanded mode can allow a user to delete the sticky note. Selecting a text area 2810 as shown in FIG. 2810 can allow a user to edit text on the sticky note using a user interface 2814 as shown in FIG. 28d. Selecting a bottom right of a sticky note can allow the user to re-size the sticky note. Dragging a top of a sticky note can be used to move the sticky on the screen. Selecting a trash can icon 2808 as shown in FIG. 28b can delete text from the current stick note.

Menu 2708 can be included in a user interface and includes options for pen, highlighter, erase, erase all, notes, leave session, join new session, register, sign in, and about.

In many embodiments, drawings with pens or highlighters and sticky notes can be added to a slide and included in a set of notes for attendees. These drawings and sticky notes can appear as overlays on the original slide image display. In embodiments where a presentation is emailed, for example in a .pdf format, drawings and sticky notes in a collapsed mode can be shown on an image. If sticky notes are used on a slide, their content can appear under a note section. Menu. 2710 shows an example of a menu that attendees can view including annotations, notes, leave session, join new session, register, sign-in and about. In some embodiments a preview screen 2716 can be shown to a user before they join a session.

As shown in FIG. 28a, sticky notes can be shown as small numbered thumbnails 2802 on a presentation screen. Additionally or alternatively, sticky notes can be referenced by individual numbers 2812 (as shown in FIG. 28c) with headers displayed adjacent to it. For example: *Note 1*—First Note Taken can be a header. In some embodiments, sticky notes in a collapsed view can be moved by touching any part of the collapsed sticky note.

Many embodiments allow users to zoom in on a screen. When a user zooms on a screen, the pen and highlighter marks can re-scale automatically and proportionately to the zooming. In some embodiments, sticky notes can remain their original size, even when zooming.

If a user logins into multiple user devices, pen and highlighter marks and sticky notes can display on the other devices, such that the user displays remain in sync. The system can include single user annotation in some embodiments. In other embodiments, collaborative, multi-user support can be included whereby multiple users are able to view annotations substantially in real-time as they are made by other users and also interact with them.

As described above, embedded objects can be included in a presentation and have an interactive life of their own. The insertion can be done when creating a presentation, such as in PowerPoint, and compiling it using a converter or by inserting special slides into the presentation in HTML format.

Embedded objects can also be multi-user, meaning that the interaction data can be provided to a server and can be used to aggregate results and enhance one or more individual user's experience during and after a presentation.

Embedded objects API can be open, in the sense that many different embedded objects can be inserted in a presentation.

Additionally, data for embedded objects can persist independently of the presentation sessions where it was collected. Traditional presentations do not collect much, if any, data on interaction. The embodiments described here enhance the presentation experience with new possibilities for interaction for presentation attendees and provide broad new analytics to presenters and moderators.

Turning to FIG. 29a, an example embodiment of a network architecture 1000 is shown. In the example embodiment a server 1400, a database 1500, smart devices including smartphones 1200, smartwatches 1700, smart eyewear 1600, smart headphones 1800, and coaching devices 1300 are communicatively coupled to a communications network 1100 such as the Internet by wired and wireless means. Additional or fewer devices are provided in varying alternative embodiments. In the example embodiment, no intermediate devices are shown although it is understood that such may be required for relaying communications over the network.

Turning to FIG. 29b, an example embodiment of a server 1400 is shown. In the example embodiment a coaching device interface 1440 and a smart device interface 1430 are provided for interfacing between external devices and a behavioral server API 1420. The behavioral server API 1420 is coupled to a server based behavior database 1410 which can store behavior data.

Turning to FIG. 29c, an example embodiment of a smart eyewear device 1600 is shown. In the example embodiment the smart eyewear device 1600 has a presentation coach application 1610 installed and operable, which can be pushed or pulled from a server or other device storing the application.

In an example embodiment the smart eyewear device can be a device such as Google Glass by Google Inc. The Google Glass device includes a monitor that sits on top of the right eye, a small speaker, a camera, a microphone, a digital compass, accelerometers, a GPS (Global Positioning System), a computer including processors, memory comparable to a smartphone, wireless connectivity including Wi-Fi and Bluetooth, among other components and features. Future developments such as use of an IPS (Indoor Positioning System) can be integrated in such devices and use of such are contemplated herein as appropriate in various presentation locations and environments.

Numerous aspects of the present system and methods will now be described and may include an audience eye contact assistant, a presenter movement detector, a pacing aid, a speech volume detector, a speech rate monitor, a speech tone detector, a speech disfluency detector and a moderator interaction module. Also included are slide control operability, a notes view and a questions view.

Audience Eye Contact Assistant

An audience eye contact assistant can use components such as one or more of the camera, compass, GPS and accelerometers in various embodiments to determine where a presenter is focusing her attention in an audience and their use can facilitate improved audience coverage. Presentation location can affect what components may be used in the particular location. For example, in some embodiments GPS may not be effective inside a building or in a basement but IPS can be used to great effect. In many embodiments the camera can detect audience location and where a presenter's field of vision is focused. Accelerometers can be used to determine when and in what direction the presenter's field of vision is changing. Similarly, the compass can be used to determine which direction the presenter's field of vision is directed. By monitoring one or more of these components including small changes in position and direction the eye contact assistant can determine in real-time how effective the presenter's eye contact is with the audience. Comparison to thresholds or other optimized eye contact models can trigger suggestions which can appear on the monitor and indicate to the presenter that she should look in a particular direction such as toward the left, right, up, down, panning across the audience or focusing on a particular location in the audience. In some embodiments the camera can be used to monitor faces in the audience to determine presentation effectiveness. If the audience eye contact assistant determines that some audience members in a particular area are lacking effective attention to the presentation (such as falling asleep or talking to each other), visual cues can indicate to the presenter the location of the audience members on the monitor. Then the presenter can focus eye contact in that location in an effort to regain or strengthen the attention of those audience members. A video recording can also be made using a built in camera which records the presentation from the presenter's point of view. This can be recalled later from memory and synched with presentation slides and/or audio in order to help the presenter review their eye contact.

Presenter Movement Detector

A presenter bounce detector can track the presenter's body movement and alert the presenter when she is moving excessively. Some distracting movements can include “bouncing” back and forth from one leg to another, jumping, swaying, leaning, walking in circles or walking back and forth, as well as others. These types of undesirable and distracting movements often occur when a presenter is uncomfortable or unfamiliar with public speaking and can be subconscious in nature. Sensors such as camera sensors, accelerometers, positional or angle detectors and directional sensors can track and record data relating to movement, can compare the data with thresholds and provide real-time notification on a monitor to inform the presenter of the movement.

Pacing Aid

A pacing aid can provide timing tracking for segments of a presentation and the presentation overall. In an example embodiment a presenter can have a specific, predetermined amount of time within which to complete a presentation. An administrator, which can be the presenter or another person, can set the total time for the presentation in a memory location prior to the start of the presentation. The memory location can be local memory or can be remote memory, such as a database on a system server. In the example embodiment a question and answer time can also be included and each slide can be given a particular time length or a total time per slide can be calculated using a formula. One formula for slide time length is:

Slide time=(Total presentation time−Question and Answer time)/Number of slides

An example of a pacing aid is shown in FIGS. 30a-30b as the slide timer 3004 and session timer 3010 in each user interface figure. During the presentation the system can monitor total session time elapsed using a timer 3010 and represent it as an icon and can also monitor a present slide timer 3004 and represent it as a separate icon. In some embodiments, time is represented as the donut that fills or empties as time passes for a current slide time. In an example, the donut can start green, turn yellow when half of the available time has elapsed, and turn red when less than a quarter of the time is left for the current slide.

As a presenter moves through a presentation by changing between slides, the slide timer 3004 can be set to the current slide's remaining time. Time used for individual slides can also be stored in memory. If a first slide has an allotment of 125 seconds and the presenter spends 50 seconds on it, then switches to a second slide before reverting back to the first slide, the timer 3004 for the first slide can continue from 50 seconds. This allows a presenter to spend a desired amount of time on particular portions of the presentation while still devoting adequate time to other portions of the presentation. Also shown are question indicator 3006, audience member indicator 3008 and slide indicator 3002. Question indicator 3006 can indicate a number of questions currently queued by audience members. An audience member indicator 3008 can include a count of how many people are currently logged into a presentation session. Slide indicator 3002 can include a number of a current slide in a presentation and a total number of slides in a presentation so a presenter can track their own progress during the presentation.

Speech Volume Detector

A speech volume detector can monitor the volume at which a presenter communicates in order to alert a presenter if she is speaking too soft or too loud for the audience to effectively hear. In an example embodiment, the device can record audio of the presentation using a microphone and calculates an average speech volume of the presenter over a preset period of time. The device can then notify the presenter to increase or decrease volume as necessary. The device will then monitor again, iteratively. After a desired volume level is attained, the device can periodically monitor the presenter's volume and notify her with visual indicators to lower or raise the speech volume. In some embodiments, with the addition of remote sensors, the volume level can be measured at several locations in the presentation space and can be combined with other sensor information to provide an indication to the presenter whether she is being heard in various locations in the presentation space.

In an example embodiment, a presenter can be standing in an auditorium in front of an audience and speaking (the source signal) with or without the use of a microphone and speakers. The presenter can have a device, such as smart eyewear, that can receive signals from one or more remote monitoring stations spaced around the auditorium. Each of the remote monitoring stations can include a microphone that receives the presenter's audio (the received signal) along with all local background noise (the ambient noise at that location). The system can compare the received signal with the source signal and provides a measure of received loudness (as estimated sound pressure level or SPL) of the source signal and Signal-to-Noise Ratio (SNR) of the received signal to the ambient noise at that location. The data from each station can be compared and presented to the speaker via audio, visual or audio-visual dashboard (on a podium or smart eyewear device). Thresholds can also be used. Feedback is given to the presenter that he/she is:

A) Speaking too quietly—If the received signal is lower than a preset threshold or if the SNR is below a preset threshold when averaged across all devices then the speaker is speaking too quietly. A visual indication of “speak up” is presented to the presenter by light, arrow or other visual element on a podium-mounted display or monitor on the smart eyewear device.

B) Speaking too loudly—If the received signal is higher than a preset threshold when averaged across all devices then the speaker is speaking too loudly. A visual indication of “speak more softly” is presented to the presenter by light, arrow or other visual element on a podium-mounted display or monitor on the smart eyewear device.

C) Is subject to distortion (in a Public Address System embodiment) such as missed or dropped audio, muffled audio or distorted audio: missed or dropped audio can be caused by radio fade (if using a radio microphone on stage) or by wireless networking issues (dropped/delayed frames in VoIP) that the speaker can address by standing still, moving to a different place on the stage and standing still, or repeating the previous portion of the presentation. A visual indication of “fade warning” can be presented to the presenter by light, arrow or other visual element on a podium-mounted display or monitor on the smart eyewear device; muffled audio can be caused by poor microphone placement that the speaker can address by re-positioning her microphone. A visual indication of “muffle warning” can be presented to the user by light, arrow or other visual element on a podium-mounted display or monitor on the smart eyewear device; distorted audio can be caused by poor microphone placement or by excessive gain on a belt-worn amplifier or elsewhere in the PA system that the speaker can address by re-positioning her microphone, turning down their local gain or instructing a sound engineer to address off-stage. A visual indication of “distortion warning” can be presented to the user by light, arrow or other visual element on a podium-mounted display or monitor on the smart eyewear device.

D) Is not being heard by portions of the audience (indicating that the presenter should move to center stage or repeat the phrase to a certain section of the audience). When comparing signals received from multiple remote monitoring stations, a “speak up” indication from one of a set of sensors can indicate that a certain part of the audience cannot hear the presenter. This can be indicated by multiple icons (one per remote station) or by an arrow indicating in which direction the presenter should speak to try and address the issue in some embodiments. In embodiments the presenter may be speaking into a microphone and cannot choose which direction to speak. In these embodiments, if the system detects an area of the audience which is not receiving adequate audio through the speakers, then it can send an alarm or other notification to technical support or a sound engineer to remedy the issue.

Speech Rate Monitor

A speech rate monitor can track a presenter's tempo and alert the presenter if she is speaking too rapidly or too slowly for the audience to effectively receive the presentation. In an example embodiment, local sensors can receive an audio signal from the presenter's speech. The received signal can be analyzed for speaking rate. Speech-To-Text functionality can be used to estimate the spoken words and compared with metrics for number of words per minute. This analysis can be used to provide feedback to instruct the presenter to speed up or slow down for their audience. This analysis can also be used to provide a “score” that can train speakers to help improve their presentation skills during practice sessions before presentations or as a post-presentation analysis.

Speech Tone Detector

A speech tone detector can monitor the tone of the presenter's speech in order to alert the presenter of the tone and pitch of her words. In an example embodiment, a presenter's voice tone raises when they are excited and this can be off-putting to audience members. The speech tone detector can monitor the highs and lows of the presenters tone and compare them to threshold values. If the presenter's voice stays above a threshold for a predetermined length of time then the detector can notify the presenter in the form of a visual cue on a monitor to lower her tone.

Speech Disfluency Detector

A speech disfluency detector monitors the content of the presenter's speech using a microphone and can alert the presenter when the presenter is using distracting utterances such as “huh”, “uh”, “erm”, “um”, “well”, “like” and other breaks, irregularities, fillers and non-lexical vocables that interrupt otherwise normal speech patterns. Such non-lexical vocables often occur when a presenter is nervous or shy, or forgets a portion of the presentation. In an example embodiment the device can monitor and record the audio portion of the presentation using the microphone and pass the recorded audio signals through a speech to text module. Based on comparison with a threshold number of non-lexical vocables the device can alert the presenter in the form of a notification such as a flashing icon on the device monitor.

The speech disfluency detector can also be programmed to detect other non-speech elements such as clicking, popping, tapping, breathing, sighing, or other sounds a presenter can make with her mouth, hands, feet, or other parts of her body. Additionally, the detector can adaptively learn or be trained to trigger on other sounds such as repetitive words, stammering, or others. In some embodiments the detector can determine “p”-popping or long “s” sounds a presenter makes during a speech. In many embodiments the system will record the entire presentation for later review by the presenter or an administrator and can generate a “score” based on pre-programmed variables to encourage improvement in future presentations.

Moderator Interaction Module

A moderator interaction module can allow a moderator to interact with a presenter to provide real-time coaching during a presentation. In an example embodiment a moderator can be seated in an audience and holding a tablet computer with a specialized, installed software program. The tablet and smart eyewear of the presenter can be communicatively coupled through a network, such as a wireless WI-FI network. The moderator can witness the presentation and interact with a user interface of the tablet computer if the moderator notices that the presenter is engaging in undesirable presentation behavior. Some examples of behavior which can be predefined include the presenter overusing hand gestures, playing with her hair, touching her face, playing with objects, looking up or down excessively, glancing at a watch frequently, fidgeting and many others. After the moderator has made the selection and elected to notify the presenter, the presenter receives the notification from the smart eyewear. In some embodiments the notification can be a pop-up, blinking, alphanumeric, icon or other visual notification on the monitor of the smart eyewear technology. In other embodiments an audible notification, a tactile notification such as a vibration, or other notification can be used to inform the presenter of the distracting behavior.

In many embodiments the moderator interaction module can be used as a backup or complement to the other coaching aids described in this application which can be fully or semi-automatic in nature.

Slide Control Operability

Slide control operability can allow a presenter to navigate through a presentation. In some embodiments this can include advancing slides or displaying exhibits at particular times during the presentation. In an example embodiment the presenter can interact with the device by pressing a button, swiping on a touchpad or otherwise touching the device. In some embodiments this can provide a haptic response such as vibrating the device to acknowledge that the command has been received by the device. In other embodiments slides can be advanced by monitoring the audio portion of the presentation using a microphone on the device and advancing when certain speech cues are given, such as the presenter saying “next slide please”. In other embodiments an inward facing camera can monitor the presenter's eye, including the pupil and iris and if the presenter performs a signal, such as blinking three times in rapid succession, the slide can be advanced.

Notes View

A notes view can allow a presenter to view notes associated with a given slide during the presentation. This can be effective where the presenter is displaying a slide for the audience and has kept associated notes but does not wish for the audience to be able to read her notes. In many embodiments the notes are displayed on a device monitor which is not viewable by the audience. In some embodiments notes for a particular slide are locked to a particular slide while in other embodiments notes can be freely scrolled through without advancing or reversing slides. In various embodiments a presenter can scroll through the notes if the notes for a particular slide are too large to fit on a monitor at one time. Scrolling can be accomplished by tactile, audio or visual means as described previously or can be automatic, at a defined and adjustable scrolling rate. An example embodiment of a slide control icon can be seen in FIG. 30a in the top left of the user interface and in FIG. 30b in the center (elements 3002). These icons 3002 indicate which number slide the presenter is on and a total number of slides in the presentation. In some embodiments an audience counter icon can be used to indicate to the presenter the number of audience members that have logged in or otherwise connected to attend the presentation with their devices as shown in the top right of FIGS. 30a-30b by icons 3008.

Questions View

A questions view can allow individual audience members or a moderator to push questions to the presenter during the course of the presentation or during a question and answer session following the content delivery portion of the presentation or during the presentation. In an example embodiment, when a presenter receives a question sent by an audience member or the moderator, the display can indicate a question has been asked by indicator 3006, display the question, and allow the presenter to read the question. After answering the question, or if the presenter wishes to skip the question or store it for a later time, the presenter can select an appropriate button on the device. An example of a question icon 3006 can be seen in FIG. 30A in the center of the user interface and in FIG. 30B in the top left of the user interface.

In embodiments where questions are controlled or filtered by a moderator, the moderator can receive all audience questions and can choose to send them to the presenter's device to display one at a time. When a question is displayed, it becomes the primary focus of the monitor of the presenter's device. Questions can also be hidden and when a question is hidden, the normal user interface screen is restored. The presenter can have limited or no control when the moderator sends questions to the presenter's device.

The example embodiments described above generally relate to a smart eyewear device as the presenter interaction device with the system and methods described herein. It should be understood that in other embodiments, additional devices or even omission of the smart eyewear device can be used in lieu of other devices. For example, a smart watch device can be used with a smartphone in some embodiments. A tablet can be used by itself in some embodiments. Smart eyewear can be used with a smart watch and a laptop computer in some embodiments. The combinations are numerous and modules, sensors, monitors, and other aids described herein can be specific or centralized on a particular device in some embodiments while in other embodiments they can be distributed over multiple devices including standalone network connected sensors and monitors.

In some embodiments, a mobile device is connected via a Wi-Fi connection to a presentation server that allows the user to see a duplicate of the presenter's screen on the device. As part of the system's functionality, the presenter can switch slides, and run polls to interact with the audience. Some embodiments herein enhance the functionality by adding some engaging features to the basic functionality. These can include one or more of the following:

Vibrate transition: This feature can allow a presenter to define one or more new vibrate transition type to be used when switching slides. This transition can cause the mobile device that is displaying the presentation to vibrate when the slide is changed, using the built-in vibrate functionality (if available). The presentation system can pre-compiles a PowerPoint or other presentation to its own internal format before it can be used, and in some embodiments requires the transition information to be preserved in the converted file.

There are alternative ways to configure this transition that do not require modifications to PowerPoint itself, including: 1) By mapping a seldom used transition onto vibrate, allowing the user to specify that transition type and replacing it during compilation with the vibrate transition, 2) By making vibrate on slide change a global setting in the cloud-based presentation application, which means all slide changes will cause a vibration, And/or 3) By including a special hidden field in the slide that can be detected by the compiler. For example, a small field with transparent text containing the word vibrate.

The client may need to know is whether the transition is enabled for the current slide, and make the device vibrate if it is. This can be done through internal programming, stored in non-transitory memory. As mentioned above, the vibration function can also be used to grab the audience's attention during particular points in a presentation. In some embodiments the vibration function can be used as an indicator to individual audience members using vibration enabled mobile devices. A particular sequence or set of vibrations can be used to indicate a correct or incorrect answer to a question, a selection for participation, or various others.

Picture poll: This feature can include a cloud-based presentation application which provide a capability to run polls during a presentation. Some embodiments can augment the functionality of a poll feature by allowing the users to take their pictures using their devices' cameras and upload the pictures to the server as part of the poll data. When displaying the poll results, the server can then select some of the images to create a background that is engaging to the participants. The background image can be done in different ways, which can be configured by the presenter running the poll. These can include: Random single image—the server can select an image from the set of images and displays it as a slide background; Random single image slide show—similar to above, but the image can be transitioned to a new image after a specified time interval; Collage of multiple random images—A set of images can be used by the server to build a collage (for example, four rows of five images) and display it as background; and/or Collage of multiple random images slide show—Same as above, but the image can be transitioned to a new one after a specified time interval.

In order to reduce the bandwidth required for these imaging features, a client can upload a notification to a server that the picture is available for upload. Then the server can notify a small subset of clients to send the picture for processing. As the images are cycled, more clients can be notified to upload additional pictures.

Picture poll with facial recognition: This feature can be an addition to the previous feature, where the picture taken by the user is analyzed with facial recognition software to obtain a mood. The possible mood values can be determined by software and defined as a range, so an average can be obtained by a processor. An example of a possible set can be: Interested—here the subject is smiling or has a positive expression; Uninterested—here the subject is not smiling or has a negative/angry expression; and/or Bored/Sleepy—here the subject has eyes closed or only half open.

In the range above, Interested is the most positive and Bored/Sleepy is the least positive, with Uninterested somewhere in between. To calculate the average value, the system can assign 10, 5 and 0 respectively and calculate the average of all measurements. The mood value can then be plotted as a mood meter for the audience. This mood meter can be displayed for the presenter and/or moderator on an appropriate display.

Pulse poll: This feature can be similar to the mood meter above, but instead of a mood value, it can use data related to the attendee's pulse, which can be read from a fitness sensor. An audience pulse value can be calculated as an average from the values received. The audience pulse value can then be displayed on a pulse meter on a presenter or moderator display to indicate an estimate of audience excitement. Automatic indicators can be coupled with the meters to indicate to a presenter or moderator that they need to increase audience interest.

In some embodiments, a multiuser presentation system can allow a presenter to show a presentation to a set of attendees, which can view the presentation on the screen or on their devices. The system can utilize a central server that maintains a database of the presentation. The presenter or moderator can controls the advancing of slides by sending commands to the server. The server can maintain slides on the attendees' devices in sync by sending messages to the clients.

During the presentation, audio from the presenter can be recorded as a continuous stream. Each time a presenter switches slides, the server can insert a marker containing the time offset from the presentation start and the current slide. Substantially simultaneously, the system can supports attendees taking notes for each slide, with the slide data being stored for later use. When the presentation ends, attendees can be permitted to download their notes, which include pointers to the corresponding slides. If the presenter allows it, the notes can also include the actual slide and the associated audio. To determine the audio that corresponds to a slide, the system can check all the markers and create audio files that match the slide. In the case where the presenter returns to a previous slide, the system can provide an audio file for each time the slide was shown or merge multiple audio files into a single file for each slide. If the presenter allows the presentation to be available to users for replay, the markers can allow an audio player to skip slides and still maintain the audio in sync. Playback in this case can be a matter of traversing the markers in order of timestamp and showing the slide indicated every time a new marker is reached. If the user selects a “Next slide” button, then the next marker can be used to determine the new audio offset and current slide.

The system can also allow for download of the one or more audio files. In this case, the entire presentation can be provided as a series of audio files, which can be named according to the segment number, time offset, the slide number and the slide title (for example: “03-time: 2:38-Slide 3-Title:Calculating ROI”).

In some embodiments, attendance and engagement the system can track students or attendees that login to maintain an attendance log. The following description will describe mainly classroom environments with teachers and students although the principles can be used in other formats as well including presenters and attendees. Metrics can include the following: was the student on time? Engagement level—Did the student take notes? Did the student switch applications during the class? Did the student use the system to ask questions? Did the student stay until the end of the class?

Implementation details: The system can be a cloud-based presentation system. In order to view slides, users can be required to login or click on a link provided by an administrator through a website, email, instant message, text message or other invitation and then enter a PIN to login to a presentation they want to attend. If PIN-attendance is turned off or otherwise disabled, only registered users can login to see a presentation. The system can track attendance by pairing users with a roster of students for a class. Additionally, the system can track if the application is put in the background (or if another application is brought to the foreground) and a user is using a different application, and if and when each user logs out. In order to avoid users signing in remotely, the system can allow logins only through a local wired, Wi-Fi, or other local network, including restricting access to a specific set of IP addresses or other paired devices connected to an access point inside the classroom.

Personalized lecture quizzes and automatic homework assignments. The system can allow a teacher to provide slides with zero or more questions per slide, a correct answer choice and multiple erroneous answer choices. The system can then utilize this information to build personal quizzes for each attendee, with questions and answers in random order which makes copying from the neighbor difficult.

Results from the tests can be used to create homework assignments for the students. The homework can be directed on those areas that caused students the most trouble and can also reinforce intermediate or strong areas. Alternatively or additionally, the teacher could provide homework assignments associated with each question, which the system could then select in a similar manner. Other homework assignments can be assigning reading, retesting missed questions from tests, suggest additional areas of study and others.

Implementation details—When creating slides current programs, such as PowerPoint and others, allow a presenter to add notes for each slide. The current system can also add a markup language to allow the text in the notes to define one or more questions, a correct answer and several wrong answers. For example, questions could be preceded by ‘̂Q:’, homework-only questions could be preceded by ‘̂H:’, correct answers by ‘̂A:’, and incorrect answers by ‘̂I:’.

An automatic quiz feature can specify the number of questions to use for each test, as well as how many possible answers to provide. The system can then create a personalized quiz for each student and store it in a database, where questions and answers are built from the data provided, but in random order, making the act of copying answers from a neighbor impossible. As students answer the questions, the system can query the database to see if each answer is correct and instantaneously provide an in-progress grade. In alternative embodiments, grades can be provided at certain checkpoints or at the end of a quiz.

Scoring—In order to make scoring fair, the system can make use of statistics in grading, taking into account the following things for each question: average time to answer and number of incorrect answers. If a question takes on average more time than others, or the percentage of wrong answers is high, then the question can be scored higher than others to compensate. The opposite can be done if the question is answered quickly and correctly by a majority. To elaborate, certain questions may cause the students more trouble than others. This can depend on multiple factors ranging from the complexity of understanding the concept to how well the teacher explained it to how receptive the class was as a whole while the concept was being explained. So, during a test, 90% of the class can fail answering a certain question while 100% of the class can easily answer another one. This feature can use these statistics to bias the grading, making the questions that few people were able to answer have greater weight during grading than the question that everybody answered correctly. If normal grading is used, for example a test with 5 questions where each question is worth 20% of the grade, students answering the hard questions correctly are rewarded the same as students answering the easy questions.

Real-time reporting—The system can provide real-time reports of class engagement. There can be different reports prepared for different audiences.

A public report can be displayed on a large screen to the class, showing: Attendance including the number of students currently logged in and a number of students signed up for the class. Engagement including a number of students that used the system to ask questions, queues for questions, and a report-creation module can allow a user to select what to display from all the information the system can make available. The system can provide some examples to get teachers started in creating their own reports. A current time or current progress through the lecture such as a percentage or number of slides completed and total number of slides can be displayed. If a quiz is in progress the system can display expected progress and time remaining.

A private report can be prepared for the teacher or other administrators showing more detailed information: Attendance—Number of students currently logged in; students with the app in the background including student names and length of time in background; percentage of students taking notes; a number of students signed up for the class; Engagement including questions asked with information about the question, the student name, a quality of question metric and a bonus points metric; current time; if a quiz is in progress: expected progress, percentage of correct answers, mean and standard deviation of time per question, hardest questions indicators, easiest questions indicators, and time remaining indicator. Additionally, after a quiz completes: question difficulty rank and score; quiz statistics information including mean and standard deviation of answer time and mean and standard deviation of quiz difficulty. For each question, the following information can be tracked: the question, a corresponding slide (if any), the number of notes taken on this slide, the number of questions asked about the slide and list of questions, the number of quizzes in which the question was used, a calculated score, the percent of correct answers, mean and standard deviation of an answer time and difficulty rankings. For each student the system can track: score, questions answered correctly, quiz difficulty/rank, cumulative rank for the class and time to complete.

An instantly scored quiz can be delivered to each student upon completion showing a summary with some or all of the following information: time taken to complete including average, best, worst; correct and incorrect answers; and grade and rank. For each question: a corresponding slide (if any), a question, a list of answers, a correct answer, and a student answer (if different from the correct one). Information cumulative for the class can include: score, grade and rank.

The enablements described in above are considered novel over the prior art and are considered critical to the operation of at least one aspect of the invention and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that the named inventor believes that the claimed subject matter is what is intended to be patented.

What is claimed is:

1. A system for real-time interactive presentation, the system communicatively coupled to a network for access by a plurality of user devices comprising:
a database to store information relating to a plurality of presentations;
at least one processor executing instructions stored in non-transitory memory that cause the processor to:
embed at least one interactive object into a page for insertion in an interactive presentation; and
store the page including the at least one interactive embedded object in a database.

2. The system for real-time interactive presentation of claim 1, wherein the second format is an HTML5 format.

3. The system for real-time interactive presentation of claim 1, wherein the at least one interactive embedded object is embedded in an HTML5 page.

4. The system for real-time interactive presentation of claim 1, wherein the instructions further cause the processor to:
receive a presentation in a first format from a presenter user device;
convert the presentation to a second format;
insert the page including the at least one interactive embedded object into a presentation at the request of a presenter.

5. The system for real-time interactive presentation of claim 4, wherein the instructions further cause the processor to:
upon a request received from a first user device for the converted presentation, transmit the converted presentation including the at least one interactive embedded object to the first user device, wherein the presentation including the at least one interactive embedded object is rendered for viewing on a display of the first user device.

6. The system for real-time interactive presentation of claim 4, wherein the at least one interactive embedded object loads itself upon the first user opening the page with the at least one interactive embedded object.

7. The system for real-time interactive presentation of claim 5, wherein the at least one interactive embedded object, upon receiving a user input, transmits and stores the user input from the first user device in the database.

8. The system for real-time interactive presentation of claim 4, wherein the at least one interactive embedded object modifies a user interface displayed to the first user depending on user inputs.

9. The system for real-time interactive presentation of claim 1, wherein the at least one interactive embedded object can automatically update.

10. The system for real-time interactive presentation of claim 6, wherein the user input can be aggregated for later analysis.

11. A method for real-time interactive presentation, implemented on a network for access by a plurality of user devices and including a database to store information relating to a plurality of presentations and at least one processor executing instructions stored in non-transitory memory that cause the processor to perform steps, comprising:
embedding at least one interactive object into a page for insertion in an interactive presentation; and
storing the page including the at least one interactive embedded object in a database.

12. The method for real-time interactive presentation of claim 11, wherein the second format is an HTML5 format.

13. The method for real-time interactive presentation of claim 11, wherein the at least one interactive embedded object is embedded in an HTML5 page.

14. The method for real-time interactive presentation of claim 11, further comprising the steps:
receiving a presentation in a first format from a presenter user device;
converting the presentation to a second format;
inserting the page including the at least one interactive embedded object into a presentation at the request of a presenter.

15. The method for real-time interactive presentation of claim 14, further comprising the steps:
upon a request received from a first user device for the converted presentation, transmitting the converted presentation including the at least one interactive embedded object to the first user device, wherein the presentation including the at least one interactive embedded object is rendered for viewing on a display of the first user device.

16. The method for real-time interactive presentation of claim 14, wherein the at least one interactive embedded object loads itself upon the first user opening the page with the at least one interactive embedded object.

17. The method for real-time interactive presentation of claim 15, wherein the at least one interactive embedded object, upon receiving a user input, transmits and stores the user input from the first user device in the database.

18. The method for real-time interactive presentation of claim 14, wherein the at least one interactive embedded object modifies a user interface displayed to the first user depending on user inputs.

19. The method for real-time interactive presentation of claim 11, wherein the at least one interactive embedded object automatically updates.

20. The method for real-time interactive presentation of claim 16, wherein the user input is aggregated for later analysis.
